(19) United States
(12) Patent Application Publication
(10) Pub. No.: US 2009/0280887 A1
(43) Pub. Date: Nov. 12, 2009

(54) Gaming Machine

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/289,040

(22) Filed: Oct. 17, 2008

(30) Foreign Application Priority Data
Oct. 19, 2007 (JP) 2007-272846

(51) Int. Cl. A63F 9/24; A63F 13/00

(52) U.S. Cl. 463/20; 463/30

(57) ABSTRACT

A slot machine begins to variably display symbols on each reel display portion. Then, the slot machine stops a symbol on each of symbol display areas. If winning combination is achieved, a main CPU displays a layout change screen, where the same kinds of the stopped symbols are collected and disposed in descending order of the number of the same kinds of the symbols, on a variable display portion. Further, the main CPU adds target symbol kind emphasis images and target symbol number notification images to the plurality of symbol display areas on which the target symbol kinds corresponding to the winning combination are displayed; and displays the layout change screen.

### CROSS-REFERENCE TO RELATED APPLICATIONS

This application is based upon and claims a priority from the prior Japanese Patent Application No. 2007-272846 filed on Oct. 19, 2007, the entire contents of which are incorporated herein by reference.

### BACKGROUND

1. Field

The present invention relates to a gaming machine that variably displays and stops symbols. More particularly, the present invention relates to a gaming machine that awards a prize according to the number of the same kinds of stopped symbols.

2. Description of the Related Art

Conventionally, there has been known a gaming machine that is provided with a symbol display portion including a plurality of symbol display areas. When a plurality of stopped symbols meet predetermined conditions, the gaming machine awards a prize according to the style of stopped symbols (for example, a gaming machine disclosed in the specification of U.S. Pat. No. 6,517,433).

The gaming machine disclosed in the specification of U.S. Pat. No. 6,517,433 employs conditions, which are based on the combination of the symbols stopped on an effective pay line, as the predetermined conditions. In this case, a player can grasp the presence or absence and the contents of the prize (that is, game result) by confirming the symbols stopped on the effective pay line.

Meanwhile, as the conventional gaming machine, there is a gaming machine that employs the number of the same kinds of the symbols stopped on a display as conditions, unlike the gaming machine disclosed in the specification of U.S. Pat. No. 6,517,433. That is, the gaming machine awards a prize, which corresponds to the number of the same kinds of the symbols stopped on the display, to a player. Accordingly, unless the player counts the number of each kind of the symbols stopped on the display, the player cannot grasp the presence or absence and the contents of the prize of the game.

The symbols stopped on the display are not necessarily disposed so as to be easily counted. In this case, the player cannot easily grasp the presence or absence and the contents of the prize. Therefore, these conventional gaming machines lay a burden on the player.

Further, in these conventional gaming machines, when grasping the contents of the prize, the player takes time to count the number of each kind of stopped symbols while the symbols are stopped. That is, while the player tries to count the number of the symbols and grasp the contents, etc. of the prize, the gaming machines do not begin to execute a new game. In other words, a period between the beginning of a new game and the termination of one game lengthens in the conventional gaming machines. As a result, the conventional gaming machines cause the decrease of the turnover of a player in the gaming machines.

The present invention has been made in consideration of the above-mentioned problem, and an object of the present invention is to provide a gaming machine that awards a prize according to the number of stopped symbols. Particularly, an object of the present invention is to provide a gaming machine that can reduce burden on a player by allowing a player to easily grasp the contents of a prize from a plurality of stopped symbols and that can increase the turnover of a player.

### SUMMARY

Therefore, in order to achieve the object, according to a first aspect of the present invention, there is provided a gaming machine comprising: a display that displays: a plurality of symbol display areas in each of which plural kinds of symbols are variably displayed and one symbol is stopped; and a symbol display portion constituted by arranging the plurality of symbol display areas in a matrix form; and a processor for executing: (a) a process for receiving a bet of a game value, and beginning to variably display the symbols on the symbol display areas; (b) a process for determining a symbol that is to be stopped on each of the symbol display areas, and stopping the determined symbol on each of the symbol display areas disposed in the form of a matrix; (c) a process for collecting by each identical kind in regard to the symbols that are stopped on the symbol display portion; (d) a process for changing layout of the symbols into a layout such that the symbols disposed in order beginning from a largest number of stopped symbols with a kind; (e) a process for displaying the symbols stopped on the symbol display portion again in accordance with the layout changed at (d); and (f) a process for determining the contents of a prize according to the number of the same kinds of symbols stopped on the symbol display portion, and awarding the determined prize.

According to this gaming machine, symbols are variably displayed on a symbol display portion where symbol display areas are disposed in the form of a matrix. Further, the determined symbols are stopped on respective symbol display areas from a variable display state. Accordingly, a plurality of symbols are displayed on the symbol display portion in the form of a matrix. Furthermore, the gaming machine awards a prize, which corresponds to the number of the same kinds of the stopped symbols, to a player.

In this case, after the symbols are stopped, the gaming machine changes the layout of the symbols that are stopped on the symbol display portion into a layout style where the symbols stopped on the symbol display portion are collected into each kind, in descending order of the number of the same kinds of the symbols stopped on the symbol display portion. Accordingly, the player can easily find out the same kinds of the symbols on the symbol display portion. As a result, the player can easily count the same kinds of the symbols. That is, the gaming machine can reduce burden on a player that is required for grasping the game result. Accordingly, the gaming machine can shorten a period that is required for the player to grasp the game result. As a result, the gaming machine can further increase the turnover of a player. In this case, since only the layout style of the symbols is changed, the kinds and the number of the stopped symbols are not changed.

According to one or more aspects of the present invention, there is provided a gaming machine comprising: a display that displays: a plurality of symbol display areas in each of which plural kinds of symbols are variably displayed and one symbol is stopped; and a symbol display portion constituted by arranging the plurality of symbol display areas in a matrix form; and a processor for executing: (a) a process for receiving a bet of a game value, and beginning to variably display the symbols on the symbol display areas; (b) a process for determining a symbol that is to be stopped on each of the symbol display areas, and stopping the determined symbol on each of the symbol display areas disposed in the form of a matrix; (c) a process for collecting by each identical kind in regard to the symbols that are stopped on the symbol display portion; (d) a process for changing layout of the symbols into a layout such that the symbols disposed in order beginning from a largest number of stopped symbols with a kind; (e) a process for displaying the symbols stopped on the symbol display portion again in accordance with the layout changed at (d); (f) a process for emphatically displaying a specific kind display area composed of symbol display areas that are collectively disposed in the symbol display portion and the same kinds of the symbols are stopped thereon; and (g) a process for determining the contents of a prize according to the number of the same kinds of symbols stopped on the symbol display portion, and awarding the determined prize.

Like the above-mentioned gaming machine, this gaming machine variably displays and stops symbols on a symbol display portion where symbol display areas are disposed in a form of a matrix. Further, the gaming machine awards a prize, which corresponds to the number of the same kinds of the symbols stopped on the symbol display portion, to a player.

In this case, after the symbols are stopped, the gaming machine changes the layout of the symbols that are stopped on the symbol display portion into a layout style where the symbols stopped on the symbol display portion are collected into each kind, in descending order of the number of the same kinds of the symbols stopped on the symbol display portion. Accordingly, the gaming machine can reduce burden on a player that is required for grasping the game result. The gaming machine emphatically displays the specific kind display area. Accordingly, the gaming machine can allow the player to more easily find out the specific kinds of the symbols stopped on the symbol display portion. As a result, the gaming machine can further reduce burden on a player that is required for grasping the game result, and further increase the turnover of a player.

According to one or more aspects of the present invention, there is provided a gaming machine comprising: a display that displays: a plurality of symbol display areas in each of which plural kinds of symbols are variably displayed and one symbol is stopped; and a symbol display portion constituted by arranging the plurality of symbol display areas in a matrix form; and a processor for executing: (a) a process for receiving a bet of a game value, and beginning to variably display the symbols on the symbol display areas; (b) a process for determining a symbol that is to be stopped on each of the symbol display areas, and stopping the determined symbol on each of the symbol display areas disposed in the form of a matrix; (c) a process for collecting by each identical kind in regard to the symbols that are stopped on the symbol display portion; (d) a process for changing layout of the symbols into a layout such that the symbols disposed in order beginning from a largest number of stopped symbols with a kind; (e) a process for displaying the symbols stopped on the symbol display portion again in accordance with the layout changed at (d); (f) a process for emphatically displaying a specific kind display area composed of the symbol display areas that are collectively disposed in the symbol display portion and the same kinds of the symbols are stopped thereon; (g) a process for displaying the number of the kinds of the symbols, which are stopped on the symbol display areas of the specific kind display area, on the specific kind display area; and (h) a process for determining the contents of a prize according to the number of the same kinds of symbols stopped on the symbol display portion, and awarding the determined prize.

Like the above-mentioned gaming machine, this gaming machine variably displays and stops symbols on a symbol display portion where symbol display areas are disposed in the form of a matrix. Further, the gaming machine awards a prize, which corresponds to the number of the same kinds of the symbols stopped on the symbol display portion, to a player.

In this case, after the symbols are stopped, the gaming machine changes the layout of the symbols that are stopped on the symbol display portion into a layout style where the symbols stopped on the symbol display portion are collected into each kind, in descending order of the number of the same kinds of the symbols stopped on the symbol display portion. Further, the gaming machine emphatically displays the specific kind display area. Accordingly, the gaming machine can reduce burden on a player that is required for grasping the game result. Furthermore, the gaming machine can increase the turnover of a player.

In addition, the gaming machine displays the number of symbols on the specific kind display area. The number of the symbol corresponds to the symbols of a specific kind displayed on the symbol display areas included in the specific kind display area. That is, the gaming machine directly notifies the player of the game result. Therefore, the gaming machine can reliably reduce burden on a player that is required for grasping the game result, and increase the turnover of a player.

According to one or more aspects of the present invention, there is provided a gaming machine comprising: a display that displays: a plurality of symbol display areas in each of which plural kinds of symbols are variably displayed and one symbol is stopped; and a symbol display portion constituted by arranging the plurality of symbol display areas in a matrix form; and a processor for executing: (a) a process for receiving a bet of a game value, and beginning to variably display the symbols on the symbol display areas; (b) a process for determining a symbol that is to be stopped on each of the symbol display areas by lottery, and stopping the determined symbol on each of the symbol display areas disposed in the form of a matrix, thereby randomly disposing the plurality of symbols on the symbol display portion; (c) a process for collecting by each identical kind in regard to the symbols that are stopped on the symbol display portion; (d) a process for changing layout of the symbols into a layout such that the symbols disposed in order beginning from a largest number of stopped symbols with a kind; (e) a process for displaying the symbols stopped on the symbol display portion again in accordance with the layout changed at (d); and (f) a process for determining the contents of a prize according to the number of the same kinds of symbols stopped on the symbol display portion, and awarding the determined prize.

Like the above-mentioned gaming machine, this gaming machine variably displays and stops symbols on a symbol display portion where symbol display areas are disposed in the form of a matrix. Further, the gaming machine awards a prize, which corresponds to the number of the same kinds of the symbols stopped on the symbol display portion, to a player.

Furthermore, when the symbol is stopped on each of the symbol display areas from a state where the symbols are variably displayed, the gaming machine determines a symbol, which is to be stopped on each of the symbol display areas, by lottery. Then, the gaming machine stops the determined symbol on each of the symbol display areas that are disposed in the form of a matrix, thereby randomly laying out the plurality of symbols on the symbol display portion. That is, immediately after the symbol is stopped on each of the symbol display areas from a state where the symbols are variably displayed, the symbols are randomly laid out on the symbol display portion. For this reason, even though looking at the symbol display portion in this state, the player cannot easily grasp the game result.

In this case, after the symbols are stopped, the gaming machine changes the random layout of the symbols that are stopped on the symbol display portion into a layout style where the symbols stopped on the symbol display portion are collected into each kind, in descending order of the number of the same kinds of the symbols stopped on the symbol display portion. Accordingly, the gaming machine can further reduce burden on a player that is required for grasping the game result, by changing the layout style of the symbols after the symbols are stopped.

### BRIEF DESCRIPTION OF THE DRAWINGS

FIG. 1 is an explanatory view with respect to a change of a variable display portion at a symbol display change process according to the first embodiment;

FIG. 2 is a perspective view of a slot machine;

FIG. 3 is an explanatory view illustrating reel display portions of the slot machine;

FIG. 4 is an explanatory view illustrating a symbol display portion of the slot machine;

FIG. 5 is a block diagram illustrating an internal constitution of the slot machine;

FIG. 6 is a block diagram illustrating an internal constitution of the sub control board of the slot machine;

FIG. 7 is an explanatory view illustrating symbols constituting each reel according to the first embodiment;

FIG. 8 is an explanatory view illustrating a symbol column constituting each reel according to the first embodiment;

FIG. 9 is an explanatory view illustrating a variable display portion upon variable display of symbols;

FIG. 10 is an explanatory view illustrating a variable display portion upon stop and display of symbols;

FIG. 11 is an explanatory view illustrating a payout table of the slot machine;

FIG. 12 is a flow chart of a main control process program;

FIG. 13 is a flow chart of a main game process program;

FIG. 14 is an explanatory view of a table associating code numbers and symbols;

FIG. 15 is an explanatory view of a table associating random number values and code numbers;

FIG. 16 is a flow chart of a symbol layout change process program;

FIG. 17 is an explanatory view with respect to a target symbol kind identification process;

FIG. 18 is an explanatory view with respect to a priority layout order determination process;

FIG. 19 is a pattern diagram illustrating a relation between each symbol display area and priority layout order;

FIG. 20 is an explanatory view illustrating an example of a layout change screen based on a symbol layout change process;

FIG. 21 illustrates a flow chart of a bonus game process program;

FIG. 22 is an explanatory view illustrating symbols constituting each reel according to the second embodiment; and

FIG. 23 is an explanatory view with respect to a change of a variable display portion at a symbol layout change process according to the second embodiment.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

### First Embodiment

An embodiment where a gaming machine according to the present invention is applied to a slot machine 1 will be described below with reference to the drawings.

A slot machine according to a first embodiment includes an image display device such as a liquid crystal display. Further, the slot machine executes a game by displaying images of various symbols on the image display device. That is, the slot machine is a so-called video slot machine.

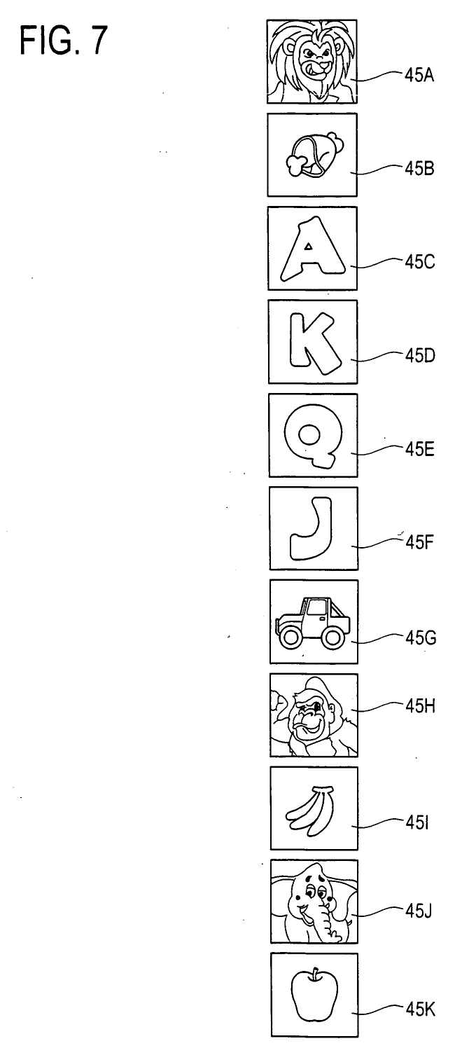

The slot machine 1 according to the first embodiment variably displays and stops a plurality of kinds of symbols (refer to FIG. 7) on a variable display portion 3B (S14). The slot machine 1 then awards a prize that corresponds to the number of the same kinds of the symbols that are stopped on the variable display portion 3B. That is, the slot machine 1 executes a game of so-called all scatter type.

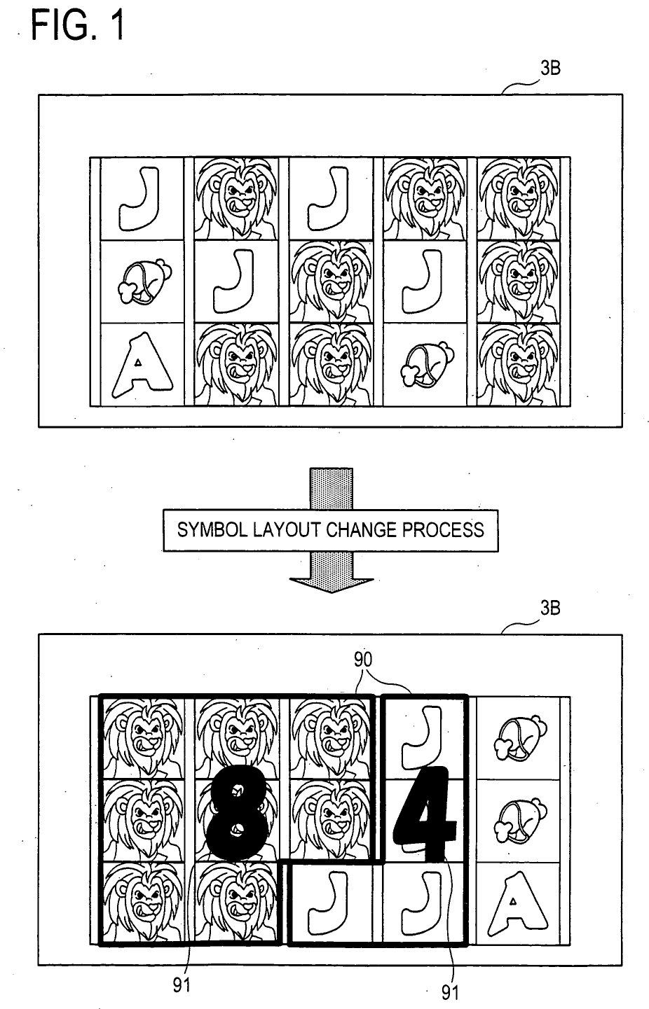

In this case, when a reel rotation control process (S14) is terminated, the slot machine 1 stops a symbol, which is determined by a symbol lottery process (S13), on each of symbol display areas of the variable display portion 3B (refer to FIG. 1). At this time, a symbol, which is randomly determined by a lottery, is stopped on the variable display portion 3B. Accordingly, a player cannot quickly grasp the kinds of the symbols stopped on the variable display portion 3B, and the number of each kind of the symbols.

If winning combination is achieved by the stopped symbols (S15: YES) after the reel rotation control process (S14), the slot machine 1 executes a symbol layout change process (S16). As a consequence, the layout of the fifteen symbols stopped on the variable display portion 3B is changed into a style where the symbols are collected into each kind, and is displayed on the variable display portion 3B (refer to FIG. 1). Therefore, a player can easily grasp the kinds and the number of the symbols stopped on the variable display portion 3B. Further, target symbol kind emphasis images 90 and target symbol number notification images 91 of the symbols that correspond to the winning combination are additionally displayed at this time. As a result, a player can more easily grasp the kinds and the number of the symbols that have achieved the winning combination.

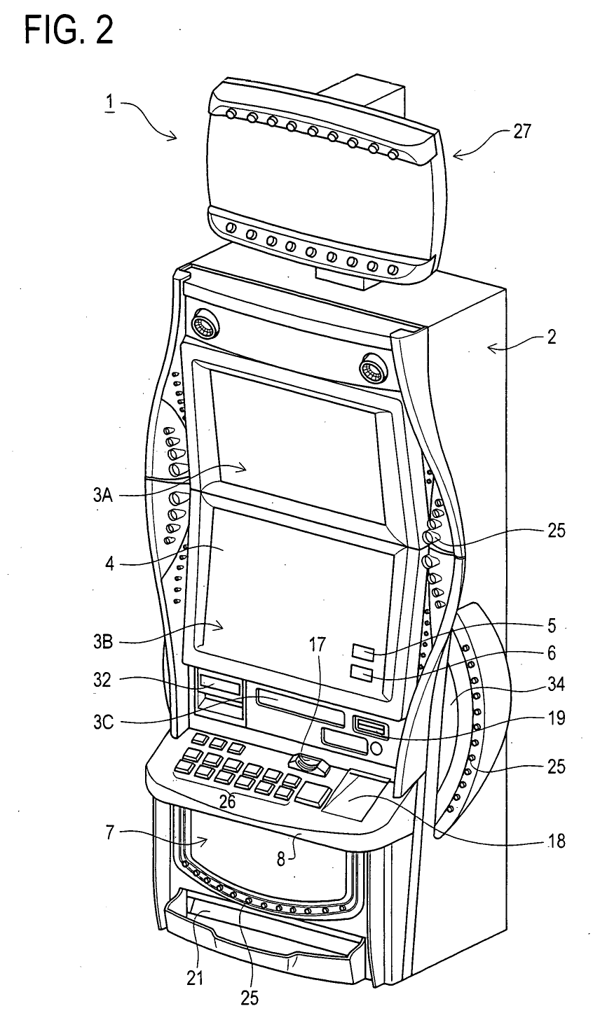

Next, the schematic structure of the slot machine 1 according to the first embodiment will be described in detail with reference to the drawings. FIG. 2 is a perspective view showing an appearance of the slot machine 1 according to the first embodiment.

The slot machine 1 according to the first embodiment is an upright slot machine that is installed in a game arcade such as a casino or the like. Meanwhile, the appearance of the slot machine 1 shown in FIG. 2 is merely one example of the present invention, and the present invention is not limited to this appearance.

As shown in FIG. 2, the slot machine 1 has a cabinet 2. The cabinet 2 serves as housing portion for housing electrical or mechanical components. These electrical or mechanical components are used in execution of a predetermined game aspect.

Further, the slot machine 1 includes an upper display portion 3A, a variable display portion 3B, and a lower display portion 3C on the front of the cabinet 2. The upper display portion 3A, the variable display portion 3B, and the lower display portion 3C display various kinds of information about a game.

The upper display portion 3A is constituted of a liquid crystal panel. Further, the upper display portion 3A is provided at the upper portion of the cabinet 2. The upper display portion 3A displays an effect image, a payout table during a game, a game rule, and the like.

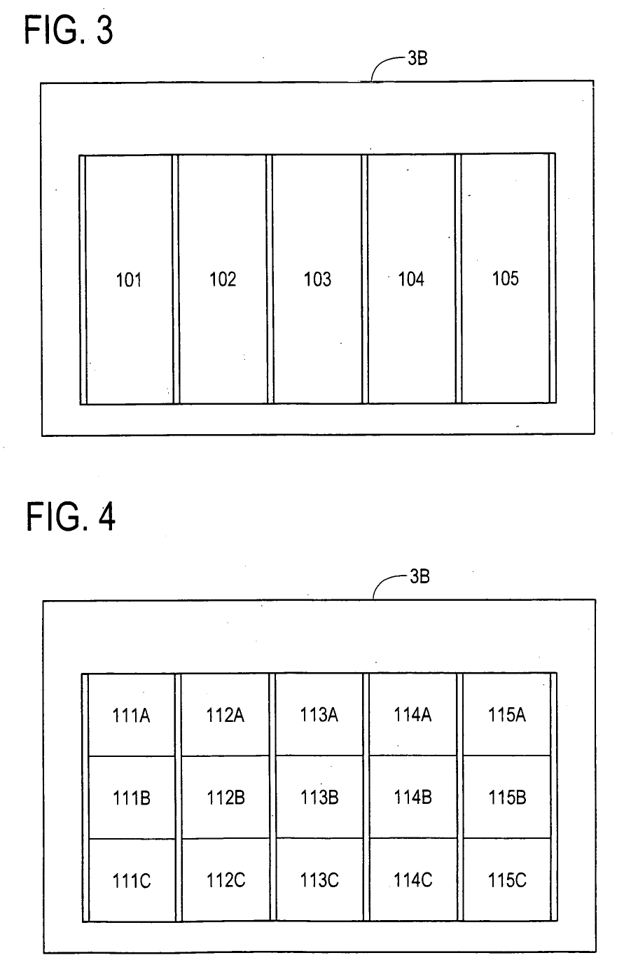

The variable display portion 3B is constituted of a liquid crystal panel. Further, the variable display portion 3B is provided at the middle portion of the cabinet 2. The variable display portion 3B has five reel display portions including a reel display portion 101 through a reel display portion 105 (refer to FIG. 3). A symbol column is variably displayed and stopped on each of the reel display portions. Each of the reel display portion 101 through 105 has three symbol display areas, respectively. More specifically, the reel display portion 101 through 105 each have symbol display areas 111A through 111C, 112A through 112C, 113A through 113C, 114A through 114C and 115A through 115C. Further, each of the symbol display areas displays a symbol (refer to FIG. 4). That is, the variable display portion 3B displays fifteen symbols in a 3×5 matrix. Meanwhile, the number of the reels and the number of the symbols displayed on one reel display portion are variable.

A touch panel 4 is located on the front face of the liquid crystal panel of the variable display portion 3B. A player can input various commands by operating the touch panel 4. Further, a payout amount display portion 5 and a credit amount display portion 6 are located at the lower right portion of the variable display portion 3B. In this case, the payout amount display portion 5 and the credit amount display portion 6 are displayed at arbitrary positions. Furthermore, a bet amount display portion for displaying the bet amount can also be provided in the variable display portion 3B. The payout amount display portion 5 displays the payout amount awarded to a player (that is, the payout amount awarded by satisfying a predetermined condition at a base game, and the accumulated payout amount acquired during a free game). The credit amount display portion 6 displays the credit amount that the player currently possesses.

The lower display portion 3C is constituted of a liquid crystal panel. Further, the lower display portion 3C is located at the lower portion of the cabinet. The lower display portion 3C displays points recorded in a card or points of a game. Meanwhile, when a card is not inserted or the reading of a card is failed, the lower display portion 3C displays the fact that the card is not inserted or the reading of the card is failed.

In addition, a card reading portion 19 is located in the vicinity of the lower display portion 3C. The card reading portion 19 reads information stored in the card that the player possesses.

Meanwhile, as described above, each of the upper display portion 3A, the variable display portion 3B, and the lower display portion 3C is constituted of a liquid crystal display in the first embodiment. However, the present invention is not limited to this form. For example, each of the display portions may be composed of a CRT display, a plasma display, an LED display, or other known displays.

A lower panel 7 is located at the lower portion of the lower display portion 3C. The lower panel 7 is composed of a plastic panel on which graphics of characters relevant to the slot machine 1, the name of the slot machine 1, and the like are drawn. The lower panel 7 is illuminated by a backlight. In this case, the lower panel 7 may be composed of a liquid crystal display, a CRT display, a plasma display, an LED, or other known displays.

An operation table 8 is located at the lower portion of the variable display portion 3B. Various operation buttons 26 (for example, an exchange button, a payout button, a help button, a BET button, a start button, and the like) are disposed on the operation table 8. Further, a coin insertion portion 17 and a bill insertion portion 18 are disposed on the operation table 8.

The position to arrange the respective types of operation buttons can be determined arbitrarily. As necessary, one portion of the respective operation buttons may be eliminated or buttons may be newly added or replaced.

Further, a coin payout portion and a coin tray 21 are formed at the lower portion of the cabinet 2. The coin payout portion serves to payout coins when the exchange button or the payout button is operated. Furthermore, the coin tray 21 serves to receive coins that were paid out from the coin payout portion. A coin detecting portion is disposed in the coin payout portion. The coin detecting portion is composed of a sensor or the like. The coin detecting portion detects the number of the coins that are paid out through the coin payout portion.

In addition, light emitting portions 25 are provided around the cabinet 2 of the slot machine 1. When a player wins a prize or plays a free game, the light emitting portions 25 light in a predetermined lighting style. Further, a speaker 34 for audio output is provided at a side face of the cabinet 2. The position to arrange the light emitting portion 25 and the speaker 34 can be determined arbitrarily.

As shown in FIG. 2, the slot machine 1 includes a topper effect device 27 at the upper portion of the cabinet 2. The topper effect device 27 has the shape of a rectangular board. Further, the topper effect device 27 is disposed substantially parallel to the upper display portion 3A. The topper effect device 27 displays various kinds of information. The shape of the topper effect device 27 can be designed arbitrarily.

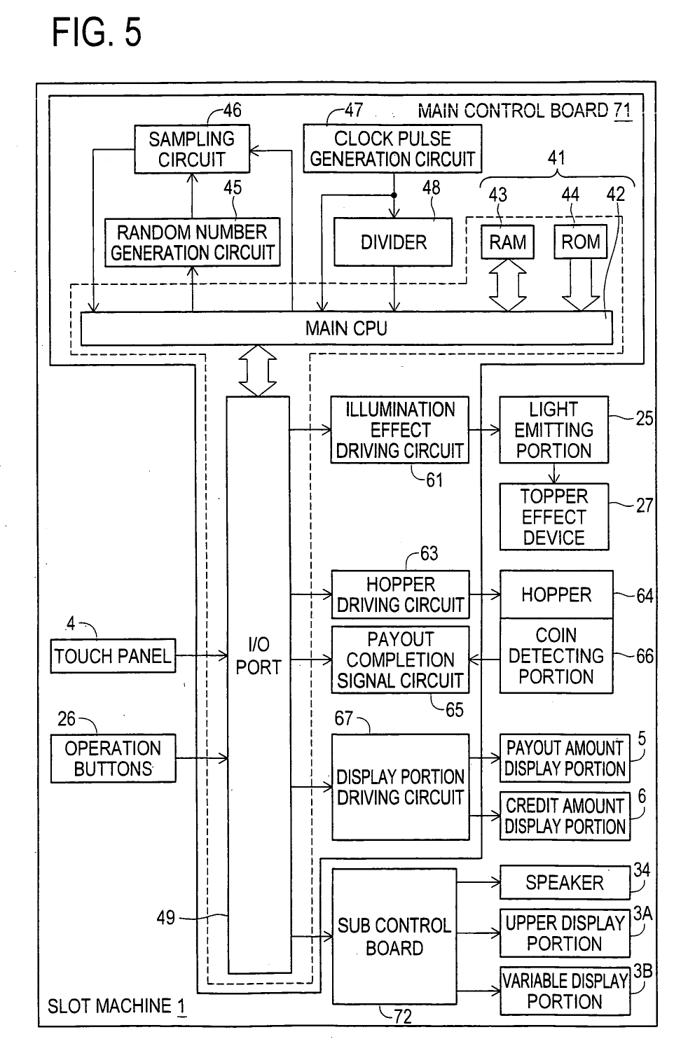

Next, the internal structure of the slot machine 1 will be described with reference to the drawings. FIG. 5 is a block diagram showing an entire internal configuration of the slot machine 1. As shown in FIG. 5, the slot machine 1 has a main control board 71, which includes a controller 41, as a functional core. Further, the slot machine 1 includes a plurality of components. The main control board 71 has the controller 41, a random number generation circuit 45, a sampling circuit 46, a clock pulse generation circuit 47, a divider 48, an illumination effect driving circuit 61, a hopper driving circuit 63, a payout completion signal circuit 65, and a display portion driving circuit 67.

The controller 41 has a main CPU 42, a RAM 43, and a ROM 44. The main CPU 42 is operated according to a program stored in the ROM 44, and executes the input and output of signals with other components through an I/O port 49. Accordingly, the main CPU 42 controls the operation of the entire slot machine 1. The RAM 43 stores data and programs that are used during the operation of the main CPU 42. For example, the RAM 43 temporarily stores a random number value, which is sampled by the sampling circuit 46, after the beginning of a game. Further, The RAM 43 stores code numbers corresponding to the reel display portion 101 through the reel display portion 105. Furthermore, the ROM 44 stores various control programs executed by the main CPU 42, and permanent data.

The programs stored in the ROM 44 include game programs and game system programs (hereinafter, referred to as game programs and the like). In addition, the game programs include lottery programs.

When the code numbers corresponding to symbols stopped at the middle positions of the reel display portions 101 through 105 of the variable display portion 3B (that is, on the symbol display areas 111B, 112B, 113B, 114B, and 115B) are determined, the lottery programs are executed.

This lottery program includes symbol weighing data. The symbol weighing data shows correspondence relationships between the respective code numbers and one or a plurality of random number values within a predetermined number value range. The probability of lottery with respect to each symbol on the reel band is set by associating one or a plurality of random number values to one code number. The random number values are drawn by lottery and symbols which are identified as final from the random number values are displayed in a predetermined area on the variable display portion 3B.

The random number generation circuit 45 is operated according to a command from the main CPU 42, and thus generates random numbers in a predetermined range. The sampling circuit 46 extracts arbitrary random numbers from the random numbers, which are generated by the random number generation circuit 45, according to the command from the main CPU 42. Further, the sampling circuit 46 inputs the extracted random numbers to the main CPU 42. The clock pulse generation circuit 47 generates a reference clock that is used to operate the main CPU 42. Furthermore, the divider 48 inputs the signals, which are obtained by dividing the reference clock at a predetermined length of cycle, to the main CPU 42.

In addition, the touch panel 4 is connected to the main control board 71. As described above, the touch panel 4 is disposed on the front face of the variable display portion 3B. Further, the touch panel 4 identifies coordinates of the position of a portion that is touched by a player. The touch panel 4 can determine the operation of the player (for instance, the portion that the player has touched, and in what direction the touched portion has moved) based on the coordinate position information thus identified. Further, a signal corresponding to the determination is input to the main CPU 42 through the I/O port 49.

Further, the operation buttons 26 (the above-mentioned start button and the like), which are used to command the executing of a game, are connected to the main control board 71 through operation switches. Accordingly, a signal in accordance with a depression operation of the operation buttons 26 is input to the main CPU 42 through the I/O port 49.

The illumination effect driving circuit 61 executes an illumination effect on the light emitting portions 25 and the topper effect device 27 by outputting an effect signal according to the command from the main CPU 42. Further, the topper effect device 27 is connected to the illumination effect driving circuit 61 through the light emitting portions 25.

The hopper driving circuit 63 drives a hopper 64 according to the control of the main CPU 42. Accordingly, the hopper 64 executes a predetermined operation, and pays out coins to the coin payout port. The coin detecting portion 24 counts the number of the coins that are paid out from the hopper 64. The coin detecting portion 24 then inputs coin amount value data showing the amount of coins that was detected to the payout completion signal circuit 65. The payout completion signal circuit 65 receives coin amount value data from the coin detecting portion 24. When the received coin amount data has reached the set coin amount value, the payout completion signal circuit 65 inputs a signal that notifies completion of coin payout to the main CPU 42. The display portion driving circuit 67 controls the display operation of the respective display portions including the payout amount display portion 5 and the credit amount display portion 6 and the like.

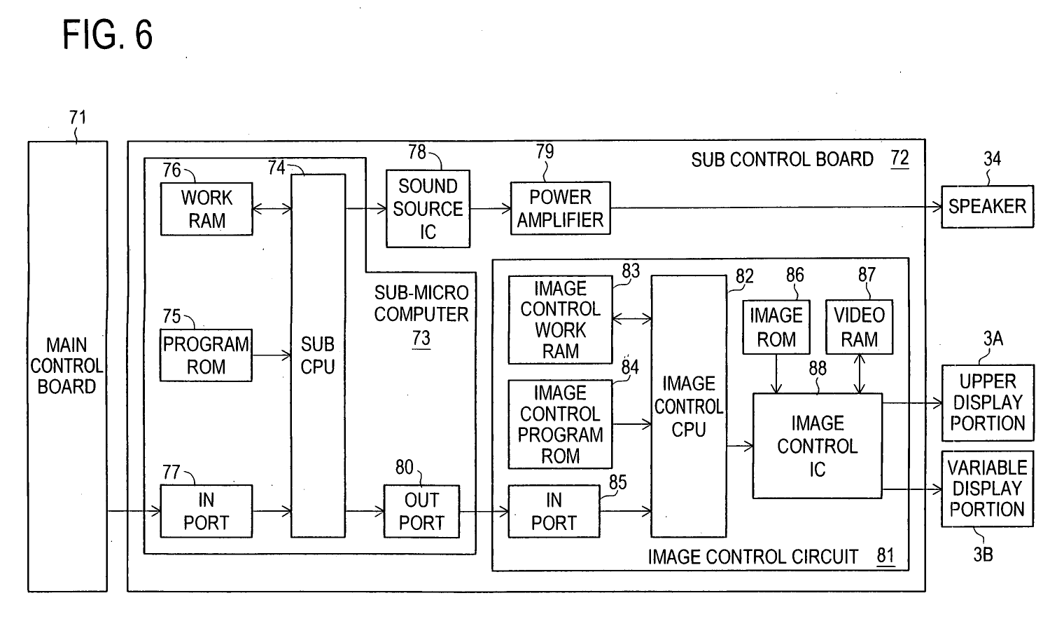

Furthermore, a sub control board 72 is connected to the main control board 71. As shown in FIG. 6, the sub control board 72 controls the display of each display portion and the audio output from the speaker 34 on the basis of the command input from the main control board 71. The sub control board 72 is provided on a circuit board that is provided separately from a circuit board that constitutes the main control board 71. The sub control board 72 includes a micro computer (hereinafter, referred to as a “sub-micro computer 73”) as a main component. Further, the sub control board 72 includes a sound source IC 78, a power amplifier 79, and an image control circuit 81. Meanwhile, the sound source IC 78 controls the audio output from the speaker 34. The power amplifier 79 functions as an amplifier that amplifies the audio output from the speaker 34. Further, the image control circuit 81 functions as a display control device of the upper display portion 3A and the variable display portion 3B.

The sub-micro computer 73 includes a sub CPU 74, a program ROM 75, a work RAM 76, and I/O ports 77 and 80. The sub CPU 74 executes a control operation according to the control command transmitted from the main control board 71. The program ROM 75 stores control programs that are executed in the sub CPU 74. The work RAM 76 is composed of a temporary memory when the control programs are executed in the sub CPU 74.

Meanwhile, the sub control board 72 does not include a clock pulse generation circuit, a divider, a random number generator, and a sampling circuit. In this case, the sub control board 72 executes random number sampling on an operation program of the sub CPU 74.

The image control circuit 81 includes an image control CPU 82, an image control work RAM 83, an image control program ROM 84, an image ROM 86, a video RAM 87, and an image control IC 88. The image control CPU 82 determines the image to be displayed on the upper display portion 3A and the variable display portion 3B based on the parameters set in the sub-micro computer 73 and the image control programs to be described later. For example, the image control CPU 82 displays a payout table or a help screen on the upper display portion 3A. Further,. the image control CPU 82 variably displays and stops a symbol on each of the symbol display areas 111A through 111C, 112A through 112C, 113A through 113C, 114A through 114C, and 115A through 115C of the variable display portion 3B. In the symbol layout change process (S16), by the image control CPU 82, each of the symbols stopped after the reel rotation process (S14) is displayed on the variable display portion 3B with layout of stopped symbols being changed in a predetermined layout style.

The image control program ROM 84 stores image control programs or various selection tables related to the display on the upper display portion 3A and the variable display portion 3B. The image control work RAM 83 functions as a temporary memory when the image control programs are executed by the image control CPU 82.

The image control IC 88 forms images that correspond to the contents determined by the image control CPU 82. The image control IC 88 outputs the formed images to the upper display portion 3A and the variable display portion 3B. The image ROM 86 stores dot data that is used to form images. The video RAM 87 functions as a temporary memory when images are formed by the image control IC 88.

Meanwhile, the internal configuration of the above-mentioned slot machine 1 is merely one example, and the present invention is not limited to this embodiment. For example, a memory card or a PLD (programmable logic device) may be detachably provided. In this case, necessary information may be read out from the memory card or the PLD.

Further, the slot machine 1 according to the present invention uses a coin, a bill, or electronic valuable information (credit) that corresponds to the coin or the bill, as a game value. However, the game value, which can be applied to the present invention, is not limited thereto. For example, the slot machine may be formed to be capable of using medals, tokens, electronic money, and tickets.

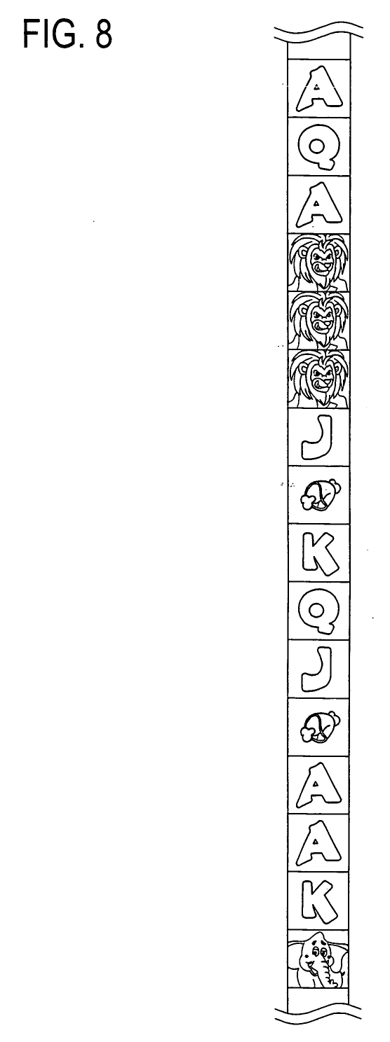

Next, the symbols which are drawn on the reel bands displayed variably on the reel display portions will be described in detail with reference to the drawings. FIG. 7 is a view showing an example of symbols that are drawn on the reel bands displayed variably on the reel display portions 101 through 105. FIG. 8 is a reel band (outer reel) that is displayed variably on each of the reel display portions.

As shown in FIGS. 7 and 8, the reel band according to the first embodiment includes a lion symbol 45A (LION), a meat symbol 45B (MEAT), an ace symbol 45C (A), a king symbol 45D (K), a queen symbol 45E (Q), a jack symbol 45F (J), a bonus symbol 45G (BONUS), a gorilla symbol 45H (GORILLA), a banana symbol 45I (BANANA), an elephant symbol 45J (ELEPHANT), and an apple symbol 45K (APPLE).

As shown in FIG. 8, various symbols shown in FIG. 7 are drawn on the reel band in a predetermined order. In this regard, the reel band shown in FIG. 8 is merely one example. The order in which the symbols are drawn may also be determined arbitrarily. The number of symbols drawn on one reel band is determined arbitrarily, and kinds of to-be-drawn symbols may also be defined arbitrarily.

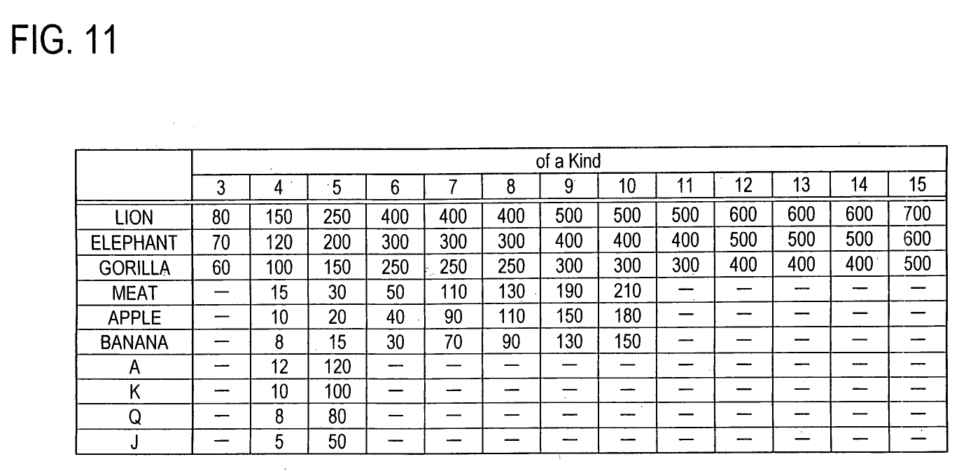

Next, a game executed in the slot machine 1 will be described. All symbols are scatter symbols in the game executed in the slot machine 1 according to the first embodiment. Specifically, in the game according to the first embodiment, a prize is awarded based on the number of same kinds of the symbols displayed on the symbol display areas 111A through 111C, 112A through 112C, 113A through 113C, 114A through 114C and 115A through 115C arranged in a 3×5 matrix in the variable display portion 3B (refer to FIG. 11).

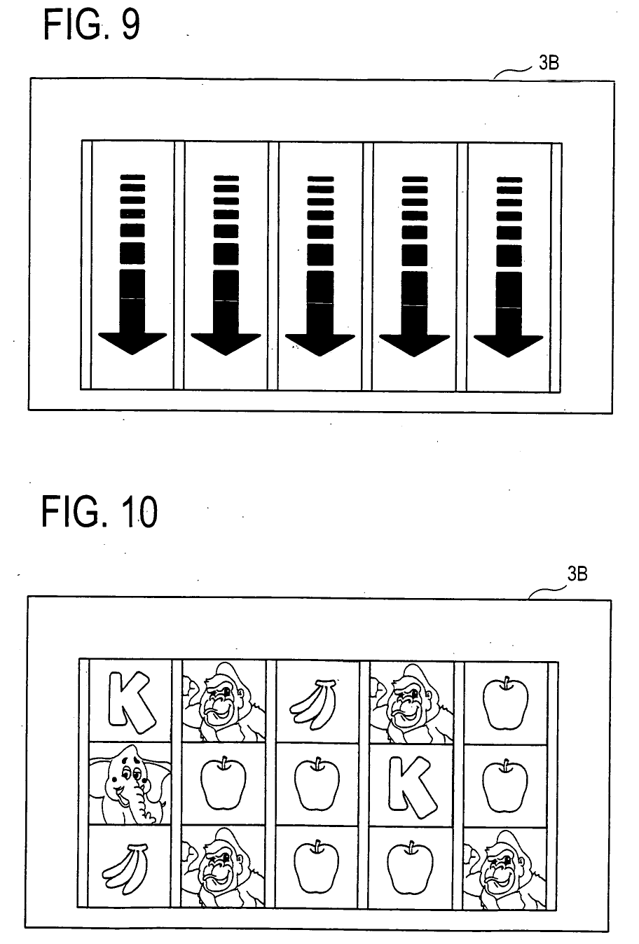

When a game starts in the slot machine 1, a player operates a BET button to set the bet amount. After that, the player presses the start button. Accordingly, a reel band starts rotation in each of the reel display portions 101 through 105. That is, in each of the reel display portions 101 through 105, a symbol column drawn on the reel band is scroll-displayed from the upper side to the lower side (refer to FIG. 9).

Further, when a predetermined time has elapsed, the reel band is stopped in each of the reel display portions 101 through 105. Consequently, a part of the symbol column drawn on each of the reel bands (three symbols of each of the reel bands) is stopped in each of the reel display portions 101 through 105. That is, as shown in FIG. 10, one symbol is stopped and displayed respectively in each of the three symbol display areas constituting each reel display portion. As a result, fifteen symbols are stopped on the variable display portion 3B (refer to FIG. 10).

The scroll direction is not limited to a direction form the upper side to the lower side, and may be a direction form the lower side to the upper side. Further, the scroll direction may vary on each of the reel display portions. Also, the scroll direction may vary in each game.

As described above, in the game of the first embodiment, winning combination is determined based on the number of the same kinds of the symbols displayed on the variable display portion 3B. A prize that corresponds to the winning combination is awarded. In the event of winning a winning combination, the player will be awarded an amount obtained by multiplying the payout amount corresponding to the winning combination by the bet amount (refer to FIG. 11). This will be described later.

Next, the winning combination and the contents of the prize in the slot machine 1 according to the first embodiment will be described with reference to the drawings. FIG. 11 is an explanatory view illustrating a payout table of the first embodiment.

As shown in FIG. 11, the payout table contains associations between the winning combination and prize to be awarded (that is, the payout amount). In this regard, the payout amount of the payout table shown in FIG. 11 is the payout amount when the bet amount is “1”. That is, when the bet amount is “1”, the payout amount shown in FIG. 11 will be paid out. Further, when the bet amount is “2” or more, the amount obtained by multiplying the bet amount by the payout amount shown in FIG. 11 will be paid out.

For example, when five ace symbols 45C are displayed on the fifteen symbol display areas (that is, the symbol display areas 111A through 111C, 112A through 112C, 113A through 113C, 114A through 114C, and 115A through 115C) of the variable display portion 3B, the “amount obtained by multiplying the bet amount by 120 credits” will be paid out to the player (refer to FIG. 11).

Further, when four jack symbols 45F are displayed on the fifteen symbol display areas of the variable display portion 3B, the “amount obtained by multiplying the bet amount by 8 credits” will be paid out to the player (refer to FIG. 11). A payout amount is set for each winning combination in a similar manner, as shown in FIG. 11.

When five or more bonus symbols 45G are displayed on the fifteen symbol display areas of the variable display portion 3B, not the payout amount but a predetermined number of so-called free games are awarded to the player. Here, the free game is a game that can be executed even though the player does not newly bet credits.

In this regard, when the symbols displayed on the fifteen symbol display areas of the variable display portion 3B do not correspond to any of the winning combinations shown in FIG. 11, the player loses. In case of losing, the player is not awarded a payout or prize.

Meanwhile, the payout table shown in FIG. 11 is an illustrative example, and the kinds of the winning combination or the contents of the prize may be set appropriately. For example, the appropriate payout amount may be set as the contents of the prize. And, bonus games (for example, a selective bonus game and the like) different from the free game or JACKPOT may also be awarded as the prize in the slot machine 1. Furthermore, a plurality of payout tables may be provided and a payout table may be selected according to a payout rate.

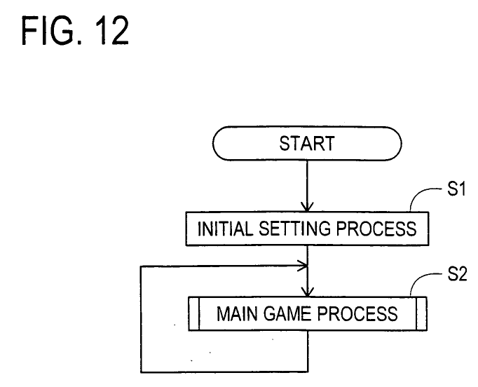

Next, a main control program executed in the slot machine 1 according to the first embodiment will be described in detail with reference to the drawings. FIG. 12 is a flowchart illustrating the main control program.

First, When the power switch is turned on (upon power on), the main control board 71 and the sub control board 72 are activated. The controller 41 executes an initial setting process (S1). In the initial setting process (S1), the main CPU 42 executes the BIOS stored in the ROM 44 and expands the compressed data incorporated in the BIOS in the RAM 43. In executing the BIOS that was expanded in the RAM 43, the main CPU 42 carries out a diagnosis and initialization of the different types of peripheral devices. Further, the main CPU 42 writes the game programs and the like from the ROM 44 into the RAM 43 to acquire payout rate setting data and country identification information. While executing the initial setting process (S1), the main CPU 42 also carries out an authentication process with respect to each program.

When the initial setting process (S1) is terminated, the main CPU 42 executes a main game process (S2). In the main game process (S2), the main CPU 42 sequentially reads out the game program and the like from the RAM 43 and executes them. By executing the main game process (S2), the game with the slot machine 1 according to the first embodiment is executed.

Meanwhile, the main game process (S2) is repeatedly executed while electric power is supplied to the slot machine 1.

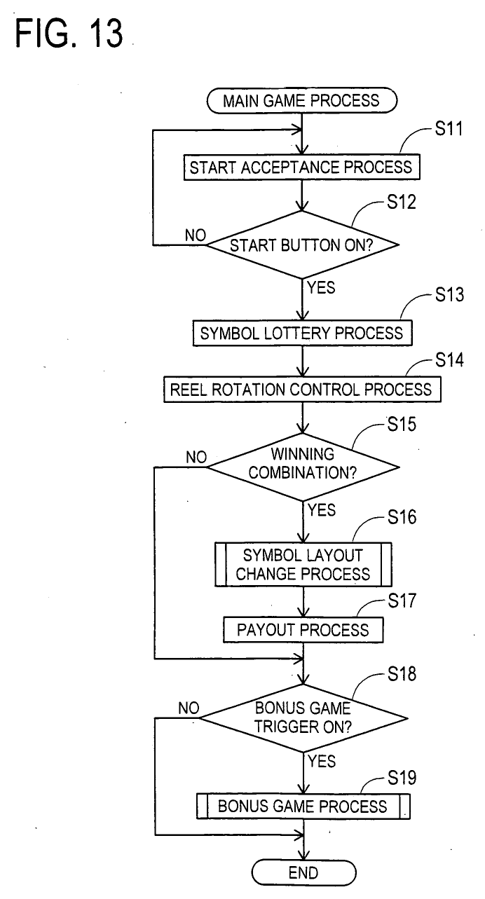

Next, a main game process program executed in the main game process (S2) will be described with reference to the drawings. FIG. 13 is a flowchart illustrating a main game process program of the slot machine 1 according to the first embodiment. Meanwhile, each of the programs illustrated in the following flowchart is stored in the ROM 44 or the RAM 43 of the slot machine 1, and is executed by the main CPU 42.

First, the main CPU 42 executes a start acceptance process (S11) as shown in FIG. 13. In the start acceptance process (S11), a player inserts coins or executes a betting operation using the BET button of the operation buttons 26.

After shifting to S12, the main CPU 42 determines whether the start button of the operation buttons 26 is pressed or not. The main CPU 42 determines whether the input to the start button exists or not on the basis of whether a signal based on the pressing of the start button exists or not. If the start button is pressed (S12: YES), the main CPU 42 subtracts the bet amount that is set based on the betting operation from the credit amount that the player currently possesses.

The main CPU 42 then stores the subtraction result in the RAM 43 as betting information. If the subtraction of the credit amount and the storing of the betting information are terminated, the main CPU 42 shifts the process to S13. On the other hand, If the start button is not pressed (S12: NO), the main CPU 42 returns the process to the start acceptance process (S11). Accordingly, the player can perform operations, such as correction of the bet amount.

After shifting to S13, the main CPU 42 executes the symbol lottery process. In the symbol lottery process (S13), the main CPU 42 executes the lottery program stored in the RAM 43 in order to sample a random number value from the numerical range of a predetermined random number value. Then, the main CPU 42 determines the symbols to be stopped on the middle portions of the reel display portions (that is, on the symbol display areas 111B, 112B, 113B, 114B, and 115B) based on the sampled random number value and the table.

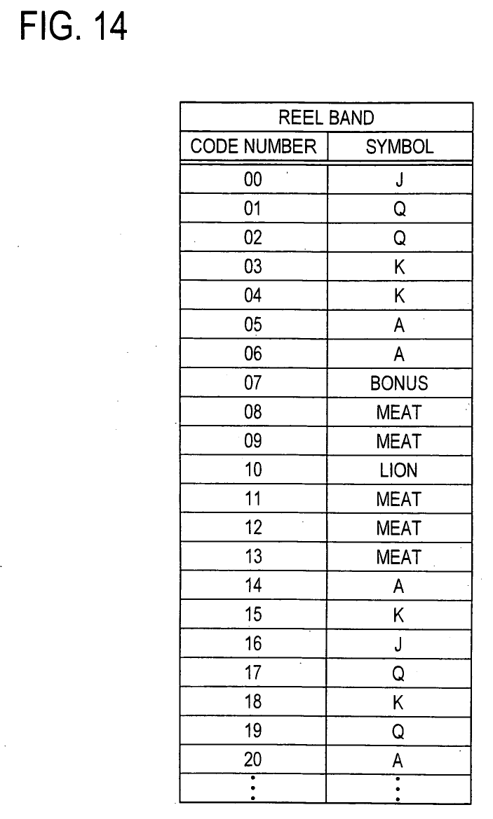

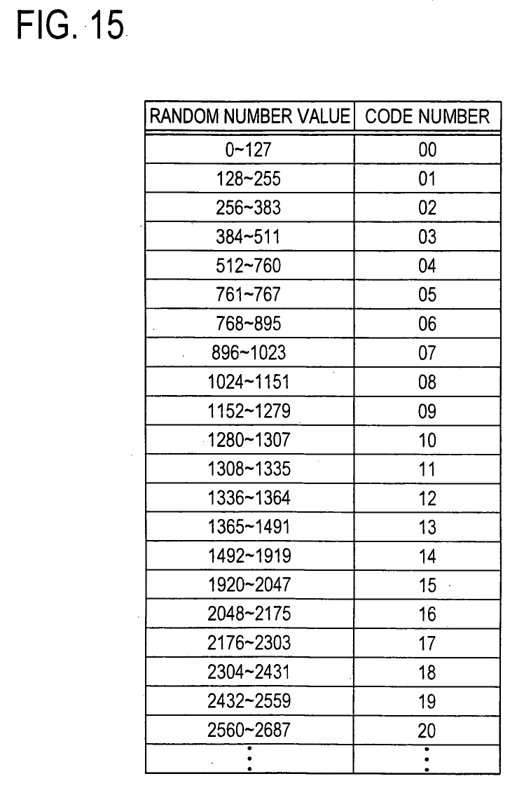

A process in which the random number value is used in the symbol lottery process (S13) will be described herein with reference to the drawings. FIG. 14 shows an example of a table associating the symbols drawn on one reel and code numbers. FIG. 15 is a view showing an example of a table associating random number values and code numbers.

In this regard, the table associating the symbols and the code numbers (for example, FIG. 14) exists so as to be associated with the reel display portions 101 through 105.

As described above, in the symbol lottery process (S13), the main CPU 42 executes the lottery program in order to sample a random number value in a predetermined random number range (for example, 0 to 65535). Then, the main CPU 42 determines a code number based on the sampled random number value and a table associating the random number values and the code numbers (for example, refer to FIG. 15). Once the code number is determined, the main CPU 42 determines a symbol to be stopped on the middle portion of the reel display portion based on the code number and a table associating symbols and the code numbers (refer to FIG. 14).

For example, when the reel band shown in FIG. 14 is used for the reel display portion 101 and a random number value “1136” is sampled, the main CPU 42 determines a code number “08” based on the random number value “1136” and the table shown in FIG. 15. Then, the main CPU 42 determines a meat symbol 45B as a symbol to be stopped on the symbol display area 111B based on the code number “08” and the table shown in FIG. 14.

The processes in executing the main game process program following the symbol lottery process (S13) will next be described while referring back to FIG. 12.

After the symbol lottery process (S13) is terminated, the main CPU 42 executes the reel rotation control process (S14). In the reel rotation control process (S14), the main CPU 42 variably displays the reel bands respectively on the reel display portions 101 through 105 at a predetermined speed. After that, the main CPU 42 determines an effect pattern (a pattern of the display of an image on the variable display portion 3B, the sound output from the speaker 34, or the like) of a unit game. The main CPU 42 starts the effects based on the effect pattern thus determined by controlling the sub-control board 72, etc. The unit game means a game that is to be executed by a series of processes until all reel bands are stopped from the time when each of the reel bands begins to be variably displayed.

When a predetermined time has elapsed, the main CPU 42 stops the reel bands on the reel display portions 101 through 105 sequentially in a predetermined order. Accordingly, one symbol is stopped on each of the fifteen symbol display areas (that is, the symbol display areas 111A through 111C, 112A through 112C, 113A through 113C, 114A through 114C, and 115A through 115C) of the variable display portion 3B. Meanwhile, as for the stop of the reel bands on the reel display portions, all reel display portions may be stopped at one time, and may be sequentially stopped with time difference.

The stop of a symbol will be described in detail with reference to the example of the reel display portion 101 that has been described in the symbol lottery process (S13). According to the above-mentioned specific example, the meat symbol 45B (code number: 8) determined in the symbol lottery process (S13) is stopped on the symbol display area 111B that is a middle portion of the reel display portion 101. In this case, the bonus symbol 45G (code number: 7) is stopped on the symbol display area 111A that constitutes an upper portion of the reel display portion 101. Further, the meat symbol 45B (code number: 9) is stopped on the symbol display area 111C that constitutes a lower portion of the reel display portion 101.

After the reel rotation control process (S14), the main CPU 42 judges whether the symbols stopped on the variable display portion 3B correspond to the winning combination (S15). Specifically, first, the main CPU 42 identifies the symbol stopped on each of the symbol display area based the code numbers of the reel display portions 101 through 105 stored in the RAM 43. When the stopped fifteen symbols are identified, the main CPU 42 stores in the RAM 43 the kinds of the stopped symbols and the number of the displayed symbols for each kind. The main CPU 42 then judges whether winning combination is achieved for the fifteen symbols. If the winning combination is achieved (S15: YES), the main CPU 42 calculates the payout amount corresponding to the winning combination based on the payout table (refer to FIG. 11). After that, the main CPU 42 shifts the process to S16. On the other hand, If any of the winning combinations is not achieved (S15: NO), the main CPU 42 shifts the process to S18.

After shifting to S16, the main CPU 42 executes the symbol layout change process. In the symbol layout change process (S16), the main CPU42 changes the layout of the symbols stopped on respective symbol display areas though the above-mentioned reel rotation control process (S14) into a style where symbols of the each identical kind are collected. At this time, the only layout of the symbols is changed. Specifically, a game result (that is, the kinds and the number of the symbols displayed on the variable display portion 3B) determined in the symbol lottery process (S13) is not changed. The symbol layout change process (S16) will be described in detail below with reference to the drawings. Accordingly, the description thereof will be omitted herein. When the symbol layout change process (S16) is terminated, the main CPU 42 shifts the process to S17.

After shifting to S17, the main CPU 42 executes a payout process. In the payout process (S17), the main CPU 42 pays out the payout amount corresponding to the winning combination determined in a process (S15) to a player. After the payout process (S17) is terminated, the main CPU 42 shifts the process to S18.

At S18, the main CPU 42 judges whether a bonus game trigger is achieved or not. Specifically, the main CPU 42 refers to the code numbers of the reel display portions 101 through 105 stored in the RAM 43. Further, the main CPU 42 judges “whether or not five or more bonus symbols 45G are stopped on the fifteen symbol display areas of the variable display portion 3B” (S18). If five or more bonus symbols 45G are stopped and the bonus game trigger is thus achieved (S18: YES), the main CPU 42 shifts the process to a bonus game process (S19). On the other hand, If the bonus game trigger is not achieved (S18: NO), the main CPU 42 terminates the main game process program.

In this case, the main game process program is executed again as soon as being terminated.

After shifting to S19, the main CPU 42 executes the bonus game process. In the bonus game process (S19), the main CPU 42 executes a predetermined number of so-called free games. The main CPU 42 then awards a prize to a player based on the result of the free game. The bonus game process will be described in detail below with reference to the drawings. After the bonus game process (S19) is terminated, the main CPU 42 terminates the main game process program.

Meanwhile, as described above, the main game process (S2) is repeatedly executed while electric power is supplied to the slot machine 1. That is, when the main game process program is terminated, the main CPU 42 begins to execute the main game process program again.

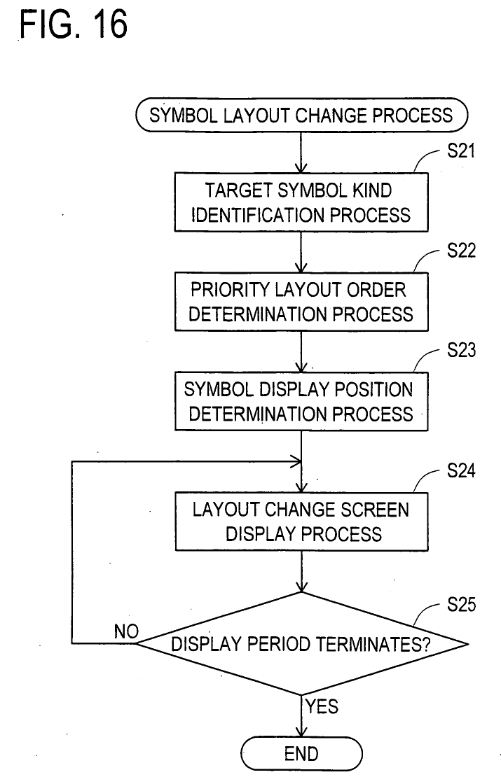

Next, a symbol layout change process program executed in a process (S16) of the main game process program will be described in detail with reference to the drawings. FIG. 16 is a flowchart illustrating a symbol layout change process program.

If a symbol layout change process program is executed, the main CPU 42 executes a target symbol kind identification process (S21). In the target symbol kind identification process (S21), the main CPU 42 identifies the kind of the symbols achieving the winning combination shown in FIG. 11. The kinds of the symbols are identified on the basis of the game result determined in the symbol lottery process (S13). That is, in the target symbol kind identification process (S21), the main CPU 42 identifies the kinds of the symbols to which the target symbol kind emphasis images 90 and the target symbol number notification images 91 shown in FIG. 1 are added (hereinafter, referred to as target symbol kinds). Specifically, the main CPU 42 identifies the kinds of the symbols achieving the winning combination based on the kinds of the symbols and the number of the displayed symbols of each kind in the game result stored at S15. Then, the main CPU 42 sets the identified kinds of the symbols as the target symbol kinds. When the target symbol kind identification process (S21) is terminated, the main CPU 42 shifts the process to S22.

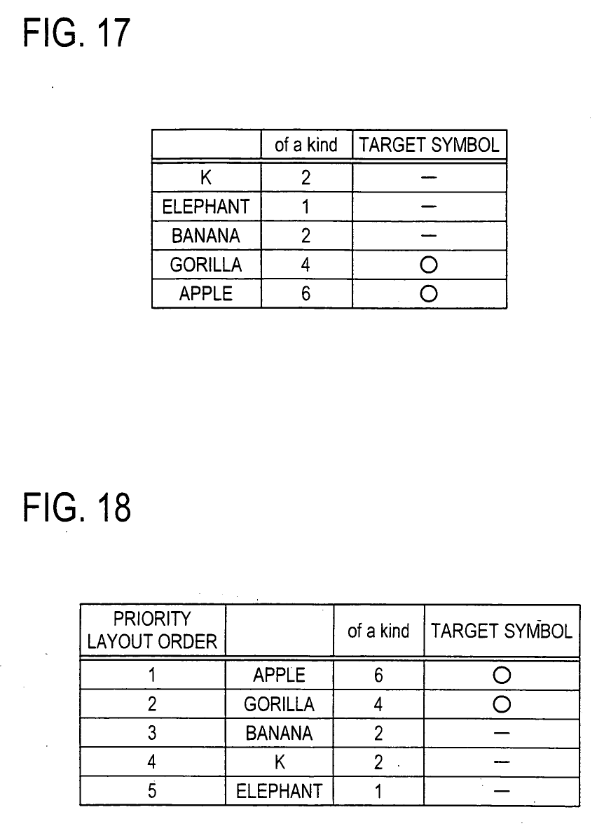

The target symbol kind identification process will be described in detail herein with reference to a specific example shown in FIG. 10. In the case of this specific example, six apple symbols 45K, four gorilla symbols 45H, two banana symbols 45I, two king symbols 45D, and one elephant symbol 45J are stopped on the variable display portion 3B (refer to FIG. 10) in the reel rotation control process (S14). Accordingly, the main CPU 42 can identify six apple symbols 45K and four gorilla symbols 45H, which correspond to the winning combination, as the target symbol kinds by referring to the information stored in the RAM 43 in S15 (refer to FIG. 17).

At S22, the main CPU 42 executes a priority layout order determination process. In the priority layout order determination process (S22), the main CPU 42 determines the kinds of the symbols that are preferentially collected on the variable display portion 3B among the stopped fifteen symbols. In the priority layout order determination process (S22), the main CPU 42 determines a priority layout order based on the conditions included the kinds, the number, and the payout amount of the stopped fifteen symbols. Once the priority layout order of all kinds of the stopped symbols is determined, the main CPU 42 shifts the process to S23.

The determination criteria of the priority layout order in the priority layout order determination process (S22) will be described. In the priority layout order determination process (S22), the main CPU 42 determines a priority layout order in accordance with a first criterion. The first criterion is “whether the kinds of symbols are the target symbol kinds or not”. The symbols corresponding to the target symbol kinds are set in a priority layout order higher than symbols that do not correspond to the target symbol kinds.

Further, in case that the priority layout order cannot be determined based on only the first criterion, the main CPU 42 determines the priority layout order in accordance with “the number of the same kinds of stopped symbols” as a second criterion. Accordingly, a higher priority of layout order is given to stopped symbols of a kind the number of which is larger than that of stopped symbol of other kind.

Furthermore, in case that the priority layout order cannot be determined based on only the first and second criteria, the main CPU 42 determines the priority layout order in accordance with “the maximum payout amount associated with the kinds of the symbols” as a third criterion. Accordingly, the symbols of which the maximum payout amount is large are set in a priority layout order higher than the symbols of which the maximum payout amount is small.

For example, in the case of the specific example shown in FIGS. 10 and 17, the apple symbol 45K and the gorilla symbol 45H, which are the target symbol kinds, are set in a priority layout order higher than the banana symbol 45I, the king symbol 45D, and the elephant symbol 45J.

The apple symbol 45K and the gorilla symbol 45H are not possible to determine a priority layout order based on only the first criterion. Accordingly, the main CPU 42 determines a priority layout order between the apple symbol 45K and the gorilla symbol 45H in accordance with the second criterion. That is, the main CPU 42 gives “priority layout order: 1”, the highest priority, to the apple symbols 45K the number of which stopped there is large. And, the main CPU 42 gives “priority layout order: 2” to the gorilla symbols 45H (refer to FIG. 18).

On the other hand, as for the banana symbol 45I, the king symbol 45D, and the elephant symbol 45J, it is not possible to determine a priority layout order among them based on only the first criterion. Accordingly, the main CPU 42 determines a priority layout order in accordance with the second criterion. In this case, there are displayed “two” banana symbols 45I, “two” king symbols 45D and “one” elephant symbol 45J. So, priority layout order of the banana symbols 45I and that of the king symbols 45D are higher than that of the elephant symbol 45J. Accordingly, the main CPU 42 sets the elephant symbol 45J in “priority layout order: 5” that is the lowest priority layout order.

Both the banana symbols 45I and the king symbols 45D are not target symbol kinds. And, the banana symbols 45I and the king symbols 45D have “2” as the number of the displayed symbols respectively. It is therefore not possible to determine a priority layout order between the banana symbol 45I and the king symbol 45D in accordance with only the first and second criteria. Thus, the main CPU 42 determines a priority layout order between the banana symbol 45I and the king symbol 45D in accordance with the third criterion. In this case, as shown in FIG. 11, the maximum payout amount “150” related to the banana symbol 45I is larger than the maximum payout amount “100” related to the king symbol 45D. Accordingly, the main CPU 42 sets the banana symbol 45I in “priority layout order: 3”, and sets the king symbol 45D in “priority layout order: 4” (refer to FIG. 18). Once priority layout orders are determined as for all kinds of the symbols in this way, the main CPU 42 terminates the priority layout order determination process (S22) and shifts the process to S23.

After shifting to S23, the main CPU 42 executes a symbol display position determination process. In the symbol display position determination process (S23), the main CPU 42 determines a symbol display area on which each of the symbols is displayed after the layout change, based on the game result determined in the symbol lottery process (S13) and the priority layout order of each kind of symbol determined in the priority layout order determination process (S22).

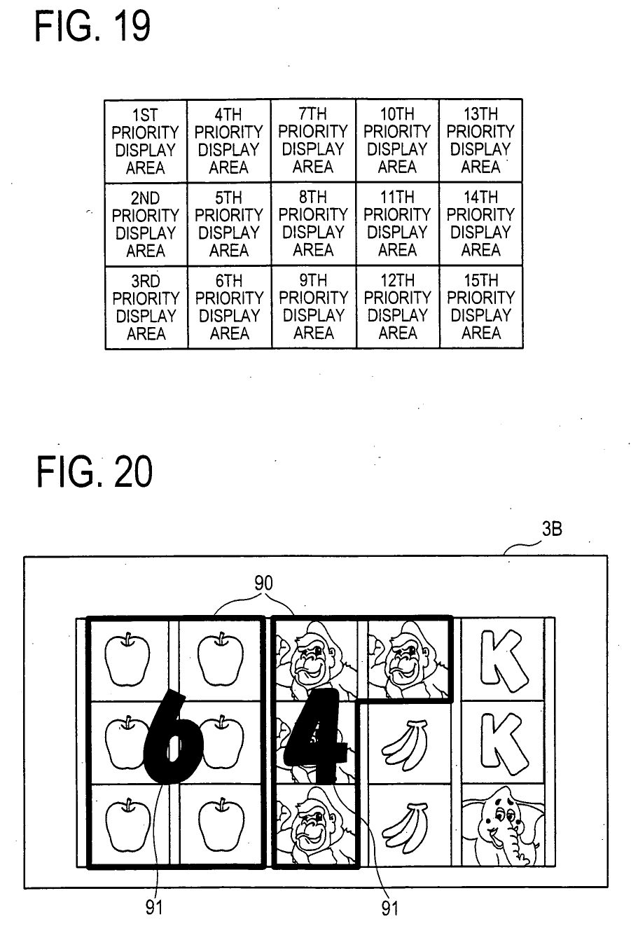

Here, each of the fifteen symbol display areas constituting the variable display portion 3B is associated with priority display orders having “first” through “fifteenth” respectively. A symbol having a high priority layout order is displayed on the symbol display area that is associated with a high priority display order. As shown in FIG. 19, “priority display order: first” is associated with the symbol display area 111A (hereinafter, the symbol display area associated with “priority display order: first” is referred to as “first priority display area”). Further, the symbol display area 111B is “second priority display area” that is associated with “priority display order: second”. A symbol display area 111C is “third priority display area” that is associated with a “priority display order: third”. Likewise, the symbol display areas 112A through 112C, 113A through 113C, 114A through 114C, and 115A through 115C are associated with the “priority display order: fourth” through “priority display order: fifteenth”, respectively. These symbol display areas correspond to “fourth priority display area” through “fifteenth priority display area” (refer to FIG. 19).

Accordingly, in the symbol display position determination process (S23), the main CPU 42 first correlates all symbols, which correspond to the “priority layout order: 1”, with the priority display areas in order beginning from “first priority display area”. The symbol display areas associated in this way become display positions of corresponding kinds of symbols after the layout change. After association all the symbols with the kind corresponding to “priority layout order: 1” with the symbol display areas, the main CPU 42 associates all the symbols with other kind corresponding to “priority layout order: 2” with the symbol display areas of the lowest priority display order among the symbol display areas that are not associated yet. Likewise, the main CPU 42 determines the display positions of all of fifteen symbols.

For example, in the case of the specific example shown in FIG. 10, FIG. 17 and FIG. 18, the main CPU 42 determines to display six apple symbols 45K associated with “priority layout order: 1” on the symbol display areas 111A through 111C and 112A through 112C which correspond to “first priority display area” through “sixth priority display area” respectively. Then, the main CPU 42 determines to display four gorilla symbols 45H associated with “priority layout order: 2” on the symbol display areas 113A through 113C and 114A which correspond to “seventh priority display area” through “tenth priority display area” respectively. Next, the main CPU 42 determines to display two banana symbols 45I associated with “priority layout order: 3” on the symbol display area 114B and 114C which correspond to “eleventh priority display area” and “twelfth priority display order” respectively. After that, the main CPU 42 determines to display two king symbols 45D associated with “priority layout order: 4” on the symbol display areas 115A and 115B which correspond to “thirteenth priority order” and “fourteenth priority order”, respectively. Furthermore, the main CPU 42 determines to display the elephant symbol 45J associated with “priority layout order: 5” on the symbol display area 115C which corresponds to “fifteenth priority display area”. After the display positions of the fifteen symbols are determined in this way, the main CPU 42 terminates the symbol display position determination process (S23). Then, the main CPU 42 shift the process to S24.

After shifting to S24, the main CPU 42 executes a layout change screen display process (S24). In the layout change screen display process (S24), the main CPU 42 changes the display positions of the fifteen symbols stopped in the reel rotation control process (S14) into the display positions determined in the symbol display position determination process (S23), and displays the symbols on the variable display portion 3B. Further, in the layout change screen display process (S24), the main CPU 42 additionally displays the target symbol kind emphasis images 90 and the target symbol number notification images 91 on the symbol display areas on which the target symbol kinds identified in the target symbol kind identification process (S21) are displayed (refer to FIG. 20). Once a layout change screen (refer to FIG. 20) is displayed on the variable display portion 3B by the layout change screen display process (S24), the main CPU 42 shifts the process to S25.

The layout change screen displayed on the variable display portion 3B in the layout change screen display process (S24) will be described in detail herein with reference to the drawings. FIG. 20 is an explanatory view illustrating an example of display of the layout change screen that is displayed on the variable display portion 3B.

As described above, on the layout change screen displayed in the layout change screen display process (S24), the layout of the fifteen symbols is changed from the layout of the symbols stopped in the reel rotation control process (S14) (refer to FIG. 10) into a style where the symbols are collected into each kind of symbols under predetermined conditions (refer to FIG. 20).

Further, as shown in FIG. 20, the target symbol kind emphasis images 90 and the target symbol number notification images 91 are displayed on the layout change screen.

The target symbol kind emphasis images 90 are images for emphasizing the symbol display areas that display the target symbol kinds identified in the target symbol kind identification process (S21). In the first embodiment, the target symbol kind emphasis images 90 emphasize the outer borders of a plurality of symbol display areas on which the target symbol kinds are stopped. That is, the target symbol kind emphasis images 90 make the display positions of the target symbol kinds (for example, the apple symbols 45K and the gorilla symbols 45H in FIG. 20) on the variable display portion 3B be apparent (refer to FIG. 20). As a result, the player can easily identify the kinds of the symbols to which payout is to be awarded (that is, the target symbol kinds) by looking at the layout change screen. Therefore, the player can easily and quickly grasp the game result.

The target symbol number notification images 91 are images showing the number of the symbols, which are stopped on the variable display portion 3B, corresponding to the target symbol kinds. The image contents of the target symbol number notification images 91 are determined based on the process in S15 and the number of the symbols corresponding to the target symbol kinds that are identified in the target symbol kind identification process (S21). The target symbol number notification images 91 are then displayed at the substantially middle portions of the plurality of symbol display areas on which the symbols corresponding to the target symbol kinds are displayed. Accordingly, the player can grasp a correspondence relationship between the target symbol number notification images 91 and the target symbol kinds by looking at the target symbol number notification images 91. In addition, the player can quickly and easily understand the number of the displayed symbols corresponding to the target symbol kinds.

After shifting to S25, the main CPU 42 determines whether or not a predetermined display period (for example, three seconds) has elapsed after the layout change screen is displayed on the variable display portion 3B. If the predetermined display period has elapsed (S25: YES), the main CPU 42 terminates the display of the layout change screen on the variable display portion 3B. Then, the main CPU 42 performs the display based on a normal reel band. Further, the main CPU 42 terminates the symbol layout change process program. On the other hand, If the predetermined display period has not elapsed yet (S25: NO), the main CPU 42 returns the process to the layout change screen display process (S24). Accordingly, the layout change screen (refer to FIG. 20) is continuously displayed on the variable display portion 3B during the predetermined display period.

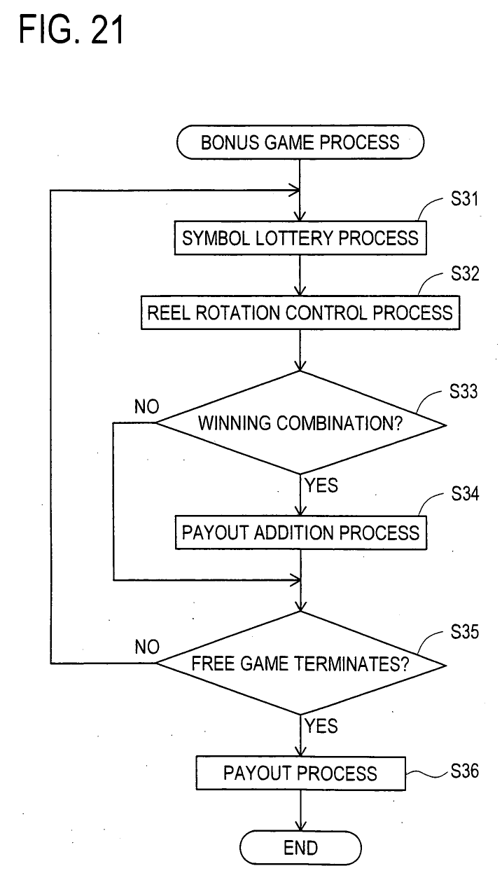

Next, a bonus game process program executed in the bonus game process (S19) will be described in detail with reference to the drawings. FIG. 21 is a flowchart illustrating a bonus game process program.

The procedure of the free game executed in the bonus game process (S19) is basically the same as that of a base game except that game values (credits) corresponding to the bet amount is not consumed at the beginning of the game and the game is automatically and successively executed without requiring a player's operation of the operation button.

Once the bonus game process program is executed, the main CPU 42 executes a symbol lottery process (S31). After the symbol lottery process (S31) is terminated, the main CPU 42 shifts the process to a reel rotation control process (S32). Then, the main CPU 42 executes the reel rotation control process. When the reel rotation control process (S32) is terminated, the main CPU 42 shifts the process to S33.

The symbol lottery process (S31) and the reel rotation control process (S32) are processes having the same contents as the symbol lottery process (S13) and the reel rotation control process (S14) of the main game process program. Accordingly, the description of the symbol lottery process (S31) and the reel rotation control process (S32) will be omitted because they have already been described.

After shifting to S33, the main CPU 42 determines whether or not the symbols displayed on the variable display portion 3B correspond to the winning combination. Specifically, the main CPU 42 determines whether or not the symbols correspond to the winning combination based on the code numbers of the reel display portions 101 through 105 and the payout table (refer to FIG. 11). If the winning combination is achieved (S33: YES), the main CPU 42 shifts the process to S34. If any winning combination is not achieved (S33: NO), on the other hand, the main CPU 42 shifts the process to S35.

In S34, the main CPU 42 executes a payout addition process. In the payout addition process (S34), the main CPU 42 sequentially adds the payout amount determined in the process S33 to the payout amount acquired during the bonus game process. The payout amount added in the payout addition process (S34) is paid out to the player in a payout process (S36) to be described below.

In S35, first, the main CPU 42 adds “1” to a value of a counter for the free game formed in the RAM 43. Then, the main CPU 42 judges whether the termination conditions of the free game are met or not. That is, the main CPU 42 judges whether the games corresponding to a predetermined number of the free games are executed or not. If the games corresponding to the predetermined number of the free games are executed (S35: YES), the main CPU 42 shifts the process to a payout process (S36). On the other hand, if the games corresponding to the predetermined number of the free games have not been executed yet (S35: NO), the main CPU 42 returns the process to the symbol lottery process (S31). Accordingly, the slot machine 1 executes another free game again.

After shifting to S36, the main CPU 42 pays out to a player the payout amount added in the payout addition process (S34). In the payout process (S36), the payout amount has been collectively paid out at one time when a predetermined number of the free games are terminated. However, the payout amount may be paid out in each of the free games.

Further, even during the execution of the free game, it may be judged whether the bonus game trigger is achieved or not. If the bonus game trigger is achieved, a “predetermined number of free games” may be awarded to the player. In this case, the main CPU 42 may add the number of the newly acquired free games to the number of the current free games that are currently stored in the RAM 43.

As described above, the slot machine 1 according to the first embodiment variably displays and stops the symbols on the variable display portion 3B. Then, the slot machine 1 awards a prize that corresponds to the number of the stopped same kinds of the symbols.

If the winning combination is achieved by the symbols stopped on the variable display portion 3B (S15: YES), the main CPU 42 executes the symbol layout change process (S16). That is, regarding indication in the variable display portion 3B, the main CPU 42 changes the screen indicated (refer to FIG. 10) at the termination of the reel rotation control process (S14) into the layout change screen (refer to FIG. 20).

In the layout change screen, the main CPU 42 displays the fifteen symbols stopped along termination of the reel rotation control process (S14) changing layout of those symbols such that symbols of each identical kind are collected and re-indicated in order beginning from the largest number of symbols with a kind. Accordingly, when looking at the variable display portion 3B, a player can easily find out the same kinds of the symbols. Therefore, the player can easily count the number of the symbols of each identical kind. As described above, the slot machine 1 awards to the player the prize corresponding to the number of the same kinds of the symbols stopped on the variable display portion 3B. Consequently, the slot machine 1 can reduce burden on a player that is required for grasping the game result.

Accordingly, the slot machine 1 can shorten a period that is required for a player to grasp the game result. As a result, the slot machine 1 can shorten a period until a player begins to play a new game or a period until a player terminates a game. Therefore, the slot machine 1 can increase the turnover of a player.

Further, in the symbol layout change process (S16), the main CPU 42 changes only the layout of the fifteen symbols stopped in the reel rotation control process (S14). That is, the main CPU 42 does not change the kinds and the number of the stopped fifteen symbols. In other words, the slot machine 1 can notify the player of the game result with an appropriate style without changing the game result determined in the symbol lottery process (S13).

The slot machine 1 identifies the kind of symbols which achieve the winning combination as the target symbol kind in the target symbol kind identification process (S21). In addition, on the layout change screen (FIG. 20), the slot machine 1 additionally displays the target symbol kind emphasis images 90 on the symbol display areas on which the symbols corresponding to the target symbol kind are displayed (S24). Accordingly, the player can easily identify the symbol display areas on which the symbols corresponding to the target symbol kinds are displayed, by the target symbol kind emphasis images 90. As a result, the slot machine 1 can further reduce burden on a player that is required for grasping the game result. Furthermore, the slot machine 1 can further increase the turnover of a player.

In addition, the slot machine 1 identifies the kind of symbols which achieve the winning combination as the target symbol kind in the target symbol kind identification process (S21). In the layout change screen (FIG. 20), the slot machine 1 additionally displays the target symbol number notification image 91 on the symbol display areas on which the symbols corresponding to the target symbol kinds are displayed (S24). Since the number of the displayed symbols corresponding to the target symbol kinds is notified by the target symbol number notification image 91, a player can grasp the number of the displayed symbols corresponding to the target symbol kinds without counting the number of symbols by oneself. That is, the slot machine 1 directly notifies a player of the game result. Therefore, the slot machine 1 can reliably reduce burden on a player that is required for grasping the game result. Furthermore, the slot machine 1 can increase the turnover of a player.

### Second Embodiment

Next, an embodiment (second embodiment) different from the above-mentioned first embodiment will be described in detail with reference to the drawings. First, a slot machine according to a second embodiment will be described.

Meanwhile, in the following description, the same reference numerals as those of the components of the slot machine 1 according to the first embodiment indicate the same components as those of the slot machine 1 according to the first embodiment or corresponding components.

Further, the schematic configuration of a slot machine according to the second embodiment is the same as that of the slot machine 1 according to the first embodiment. Furthermore, various control processes also are almost the same as those of the slot machine 1 according to the first embodiment.

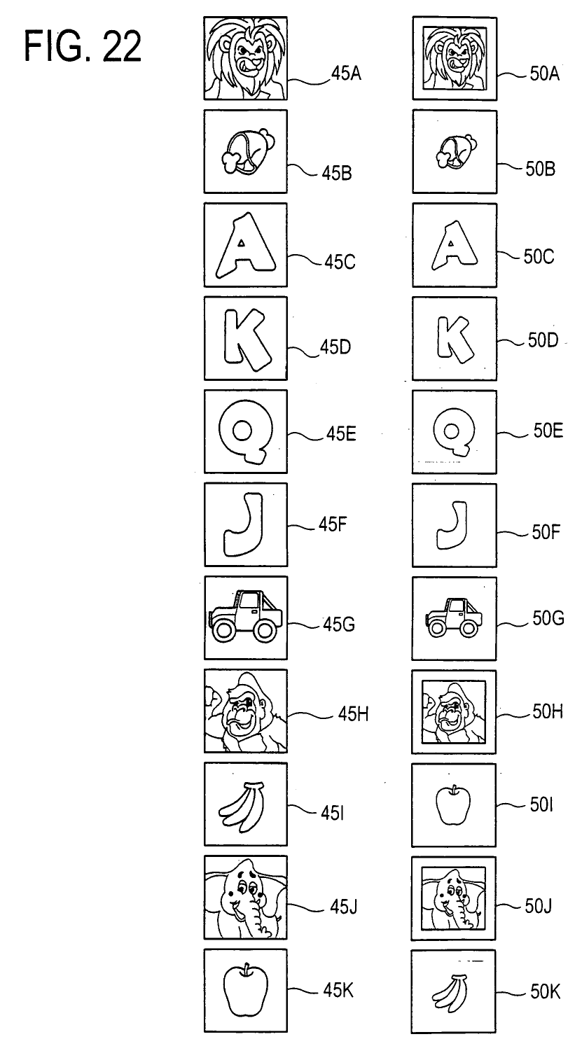

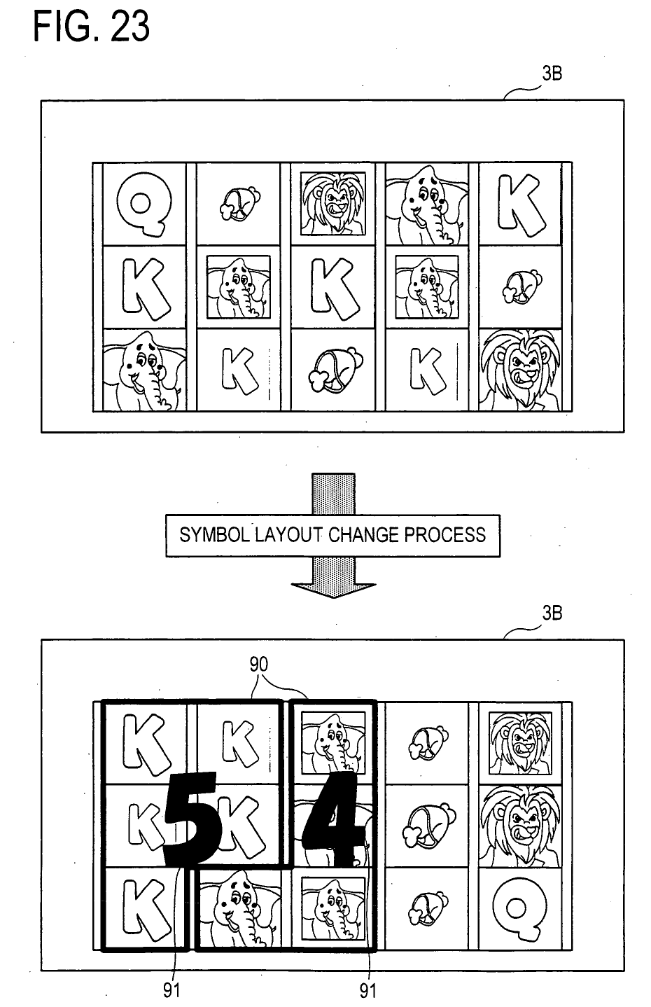

However, eleven kinds of mini-symbols 50 are further used in the slot machine 1 according to the second embodiment, in addition to the eleven kinds of symbols (that is, the lion symbol 45A through the apple symbol 45K) used in the first embodiment (refer to FIG. 22). Accordingly, the mini-symbols 50, and control programs of which processes vary due to the mini-symbols 50 will be described in detail.

First, symbols which form a reel band used in the slot machine 1 according to the second embodiment will be described in detail with reference to the drawings. FIG. 22 is an explanatory, view showing the symbols that form the reel band of the slot machine according to the second embodiment.

As shown in FIG. 22, the reel band of the second embodiment can include eleven kinds of mini-symbols 50 in addition to the eleven kinds of symbols that are the same as symbols used in the above-mentioned first embodiment (that is, the lion symbol 45A through the apple symbol 45K). The mini-symbols 50 include a mini-lion symbol 50A (Mini-LION), a mini-meat symbol 50B (Mini-MEAT), a mini-ace symbol 50C (Mini-A), a mini-king symbol 50D (Mini-K), a mini-queen symbol 50E (Mini-Q), a mini-jack symbol 50F (Mini-J), a mini-bonus symbol 50G (Mini-BONUS), a mini-gorilla symbol 50H (Mini-GORILLA), a mini-banana symbol 50I (Mini-BANANA), a mini-elephant symbol 50J (Mini-ELEPHANT), and a mini-apple symbol 50K (Mini-APPLE).

As shown in FIG. 22, the design of the eleven kinds of mini-symbols 50 (that is, the mini-lion symbol 50A through the mini-apple symbol 50K) is the same as that of the eleven kinds of symbols (that is, the lion symbol 45A through the apple symbol 45K), and the eleven kinds of mini-symbols are formed of the design of which only the size is reduced. Each of the eleven kinds of mini-symbols 50 has the same function as the symbol having the same design.

For example, the mini-lion symbol 50A has the same function as the lion symbol 45A. If the mini-lion symbol 50A stopped on the variable display portion 3B as a game result, the mini-lion symbol 50A is handled as the lion symbol 45A. Likewise, the other mini-symbols 50 (that is, the mini-meat symbol 50B through the mini-apple symbol 50K) are handled as symbols that are same in design but different in size (that is, the meat symbol 45B through the apple symbol 45K). This will be described later.

Like the reel band shown in FIG. 8, various symbols shown in FIG. 22 (that is, eleven kinds of symbols and eleven kinds of mini-symbols 50) are drawn on the reel band of the second embodiment in a predetermined order. In this regard, like in the first embodiment, the order in which the symbols are drawn on the reel band related to the second embodiment may also be determined arbitrarily. The number of symbols drawn on one reel band is determined arbitrarily, and kinds of to-be-drawn symbols may also be defined arbitrarily.

The slot machine according to the second embodiment is controlled on the basis of the same program as the main control process program of the first embodiment (refer to FIG. 12).

However, since the mini-symbols 50 exist in the second embodiment, a part of the processes of the main game process program (refer to FIG. 13), the symbol layout change process program (refer to FIG. 16), and the bonus game process program (refer to FIG. 21) are different from the processes of the first embodiment.

First, a main game process program of the slot machine 1 according to the second embodiment will be described. Like the first embodiment, even in the slot machine 1 according to the second embodiment, after shifting to the main game process (S2), the main CPU 42 executes a main game process program (FIG. 13).

Starting the execution of the main game process program, the main CPU 42 executes the start acceptance process (S11) and the judgment process (S12). The processes (S11 and S12) are the same processes as those of the first embodiment. Accordingly, the description thereof will be omitted.

After shifting to S13, the main CPU 42 executes a symbol lottery process. In the symbol lottery process (S13), the main CPU 42 samples a random number value for each reel display portion, and identifies a code number based on the sampled random number value and the table associating the random number values and the code numbers (for example, refer to FIG. 15). Further, the main CPU 42 determines symbols to be stopped on symbol display areas of each reel display portion based on the identified code number and the table associating the code numbers and symbols.

In the second embodiment, eleven kinds of mini-symbols 50 as well as eleven kinds of symbols (the lion symbol 45A to the apple symbol 45K) correspond to the code numbers in the table associating the code numbers and the symbols. Thus, eleven kinds of mini-symbols (the mini-lion symbol 50A and the like) as well as eleven kinds of symbols (the lion symbol 45A and the like) can be determined as the symbols to be stopped on each of the symbol display area.

In S14, the main CPU 42 executes a reel rotation control process. In this case, the reel rotation control process (S14) of the second embodiment is the same as that of the first embodiment except that the table associating the code numbers and the symbols related to the second embodiment is used. Therefore, the description of the reel rotation control process (S14) of the second embodiment will be omitted.

After shifting to S15, the main CPU 42 judges whether winning combination is achieved or not. At the judgment process in S15 related to the second embodiment, the main CPU 42 judges whether the winning combination is achieved while handling the mini-symbols 50 stopped on the variable display portion 3B as the symbol that are same in design but different in size. If the winning combination is achieved (S15: YES), the main CPU 42 shifts the process to S16. On the other hand, if the winning combination is not achieved (S15: NO), the main CPU 42 shifts the process to S18.

A judgment process (S15) of the second embodiment will be described in detail with reference to an example shown in FIG. 23. As shown in FIG. 23, three king symbols 45D, two mini-king symbols 50D, two elephant symbols 45J, two mini-elephant symbols 50J, one meat symbol 45B, two mini-meat symbols 50B, one lion symbol 45A, one mini-lion symbol 50A, and one queen symbol 45E are stopped on the variable display portion 3B in this specific example.

In this case, the main CPU 42 judges whether the winning combination is achieved while handling each of two mini-king symbols 50D as the two king symbols 45D. Accordingly, the main CPU 42 judges that five king symbols 45D are stopped on the variable display portion 3B. The main CPU 42 judges that the winning combination corresponding to the five king symbols 45D is achieved. Likewise, in the case of FIG. 23, the main CPU42 handles each of two mini-elephant symbols 50J as the two elephant symbol 45J. Accordingly, the main CPU 42 judges that the winning combination corresponding to four elephant symbols 45J is achieved. Likewise, the main CPU 42 judges whether the winning combination is achieved while handling the mini-meat symbol 50B and the mini-lion symbol 50A as the meat symbol 45B and the lion symbol 45A respectively.

In S16, the main CPU 42 executes a symbol layout change process. The symbol layout change process of the second embodiment will be described in detail below. Accordingly, the description thereof will be omitted. Further, a payout process (S17) executed after S16 is the same as that of the first embodiment. Accordingly, the description thereof will be omitted.

After shifting to S18, the main CPU 42 judges whether a bonus game trigger is achieved or not. In this judgment process at S18 related to the second embodiment, the main CPU 42 judges whether a bonus game trigger is achieved while handling the mini-bonus symbol 50G as the bonus symbol 45G. That is, the main CPU 42 executes the determination in S18 on the basis of “whether the sum of the numbers of the bonus symbols 45G and mini-bonus symbols 50G stopped on fifteen symbol display areas that constitute the variable display portion 3B is five or more”.

If the bonus game trigger is achieved (S18: YES), the main CPU 42 shifts the process to a bonus game process (S19). The bonus game process (S19) will be described later. On the other hand, if the bonus game trigger is not achieved (S18: NO), the main CPU 42 terminates the main game process program.

Next, a symbol layout change process program according to the second embodiment will be described in detail. After shifting to the symbol layout change process (S16), the main CPU 42 begins to execute a symbol layout change process program.

Even in the second embodiment, starting the execution of the symbol layout change process program, the main CPU 42 executes the target symbol kind identification process (S21). In this regard, the target symbol kind identification process in the second embodiment is that same as that in the first embodiment except that the mini-symbols 50 (for example, the mini-banana symbols 50I) are handled as symbols that are same in design but different in size (for example, the banana symbols 45I). If the target symbol kind identification process (S21) is terminated, the main CPU 42 shifts the process to S22.

The target symbol kind identification process will be described herein with reference to the specific example shown in FIG. 23. In this case, three king symbols 45D and two mini-king symbols 50D are stopped on the variable display portion 3B. As described above, each of two mini-king symbols 50D is handled as the king symbol 45D. Accordingly, the winning combination corresponding to five king symbols 45D is achieved in this case (refer to FIG. 11). Therefore, the main CPU 42 judges the king symbol 45D (including the mini-king symbol 50D) as a target symbol kind. Further, two elephant symbols 45J and two mini-elephant symbols 50J are stopped on the variable display portion 3B in this specific example. In the second embodiment, the mini-elephant symbol 50J is handled as the elephant symbol 45J. Accordingly, the winning combination corresponding to four elephant symbols 45J (refer to FIG. 11) is achieved in the case of FIG. 23. Thus, the main CPU 42 also judges the elephant symbol 45J (including the mini-elephant symbol 50J) as a target symbol kind.

After shifting to S22, the main CPU 42 executes the priority layout order determination process. Even in the priority layout order determination process of the second embodiment, like in the first embodiment, the main CPU 42 determines the kinds of the symbols which are preferentially collected and displayed on the variable display portion 3B, among the stopped fifteen symbols on the basis of the first criteria through the third criteria.

In this regard, in the priority layout order determination process (S22) related to the second embodiment, the main CPU 42 handles the mini-symbols 50 as the symbols with the same kinds that are same in design but different in size, when executing the process to determine the priority layout order on the basis of the first criteria through the third criteria on condition described above. If the priority layout order of all kinds of the stopped symbols is determined, the main CPU 42 shifts the process to S23.

The priority layout order determination process (S22) of the second embodiment will be described herein with reference to the specific example shown in FIG. 23. As described above, the king symbol 45D (including the mini-king symbol 50D) and the elephant symbol 45J (including the mini-elephant symbol 50J) are identified as target symbol kinds in the case of FIG. 23. In this specific example, the number of the displayed king symbols 45D including the displayed mini-king symbols 50D is “5”. And, the number of the displayed elephant symbols 45J including the displayed mini-elephant symbols 50J is “4”. Accordingly, the main CPU 42 sets the king symbol 45D (including the mini-king symbol 50D) in the “priority layout order: 1” based on the first criteria and the second criteria. Then, the main CPU 42 sets the elephant symbol 45J (including the mini-elephant symbol 50J) in the “priority layout order: 2”.

The number of the displayed meat symbols 45B (including the displayed mini-meat symbols 50B) is “3” in the case of the specific example shown in FIG. 23. Further, the number of the displayed lion symbols 45A (including the displayed mini-lion symbols 50A) is “2”. In addition, one queen symbol 45E is displayed on the variable display portion 3B. Accordingly, the main CPU 42 determines a priority layout order of these three kinds of the symbols based on the first criteria and the second criteria. That is, the main CPU 42 sets the meat symbol 45B (including the mini-meat symbol 50B) in the “priority layout order: 3”. The main CPU 42 sets the lion symbol 45A (including the mini-lion symbol 50A) in the “priority layout order: 4”. The main CPU 42 also sets the queen symbol 45E in the “priority layout order: 5”.

In S23, the main CPU 42 executes a symbol display position determination process. In the symbol display position determination process (S23), the main CPU 42 determines the symbol display area on which each symbol is displayed after the layout change based on the priority layout order of each kind of symbol determined in the priority layout order determination process (S22). If the symbol display position determination process (S23) is terminated, the main CPU 42 shifts the process to S24.

As described above, in the priority layout order determination process (S23) of the second embodiment, the mini-symbols 50 are handled as the same kinds of symbols that are same in design but different in size. Accordingly, even in the symbol display position determination process (S23), the main CPU 42 handles the mini-symbols 50 in the same manner.

Meanwhile, the symbol display position determination process (S23) in the second embodiment is the same as the symbol display position determination process in the first embodiment except for the handling of the mini-symbols 50.

The symbol display position determination process (S23) according to the second embodiment will be described herein with reference to the specific example related to FIG. 23. As described above, the king symbol 45D (including the mini-king symbol 50D) is set in the “priority layout order: 1” in the priority layout order determination process (S22). Further, the number of the displayed king symbols 45D and the mini-king symbols 50D is “5” in this case. Accordingly, the main CPU 42 associates the king symbols 45D (including the mini-king symbols 50D) with “first priority display area” through “fifth priority display area”. The main CPU 42 then associates four elephant symbols 45J (including the mini-elephant symbols 50J) corresponding to the “priority layout order: 2” with “sixth priority display area” through “ninth priority display area”. Likewise, the main CPU 42 associates the meat symbols 45B (including mini-meat symbols 50B) corresponding to the “priority layout order: 3”, the lion symbols 45A (including mini-lion symbol 50A) corresponding to the “priority layout order: 4”, and the queen symbol 45E corresponding to the “priority layout order: 5” sequentially with “tenth priority display area” through “fifteenth priority display area”.

In S24, the main CPU 42 executes a layout change screen display process. The layout change screen display process (S24) according to the second embodiment is the same as the layout change screen display process according to the first embodiment. That is, the main CPU 42 displays associated symbols on the symbol display areas determined in the symbol display position determination process (S23). The main CPU 42 displays target symbol kind emphasis images 90 and target symbol number notification images 91 in addition to the target symbol kinds identified in the target symbol kind identification process (S21).

Accordingly, a layout change screen is displayed on the variable display portion 3B as shown in FIG. 23. On the layout change screen, as shown in FIG. 23, the target symbol kind emphasis images 90 and the target symbol number notification images 91 are added to the king symbols 45D (including the mini-king symbols 50D) and the elephant symbols 45J (including the mini-elephant symbols 50J) that are the target symbol kinds.

After the layout change screen is displayed, the main CPU 42 displays the layout change screen on the variable display portion 3B until a predetermined display period elapses (S24, S25: NO). Further, when the predetermined display period has elapsed, the main CPU 42 terminates the symbol layout change process program.

Subsequently, a bonus game process program according to the second embodiment will be described. In the slot machine 1 according to the second embodiment, after shifting to the bonus game process (S19), the main CPU 42 executes a bonus game process program.

Starting the execution of the bonus game process program, the main CPU 42 sequentially executes a symbol lottery process (S31), a reel rotation control process (S32), and a judgment process in S33. The processes in S31 through S33 are the same as the processes in S13 through S15 of the main game process program according to the second embodiment.

That is, in the symbol lottery process (S31) and the reel rotation control process (S32) according to the second embodiment, the main CPU 42 executes processes by using a table associating the code numbers, eleven kinds of symbols (the lion symbol 45A through the apple symbol 45K), and eleven kinds of mini-symbols 50 (the mini-lion symbol 50A through the mini-apple symbol 50K). The other contents of the symbol lottery process (S31) and the reel rotation control process (S32) are the same as those of the above-mentioned first embodiment.

Further, in the judgment process in S33, the main CPU 42 judges whether the winning combination is achieved on condition described above while handling the mini-symbols 50 as the symbols with the same kind that are same in design but different in size. That is, the judgment process (S33) is the same as the judgment process in S33 in the first embodiment except that the mini-symbols 50 (for example, the mini-apple symbols 50K) are handled as symbols that are same in design but different in size (for example, the apple symbols 45K).

Furthermore, in the bonus game process program of the second embodiment, the contents of the payout addition process (S34) through the payout process (S36) are the same as those of the payout addition process (S34) through the payout process (S36) of the first embodiment. For this reason, the description of the payout addition process (S34) through the payout process (S36) of the second embodiment will be omitted. In the second embodiment, the main CPU 42 also terminates the bonus game process program when the payout process (S36) is terminated.

As described above, in the slot machine 1 according to the second embodiment like in the slot machine 1 according to the first embodiment, if the winning combination is achieved by the symbols stopped on the variable display portion 3B (S15: YES), the main CPU 42 executes the symbol layout change process (S16). That is, regarding indication in the variable display portion 3B, the slot machine 1 according to the second embodiment changes the screen indicated at the termination of the reel rotation control process (S14) into the layout change screen (refer to FIG. 23).

In this case, the slot machine 1 according to the second embodiment variably displays and stops the mini-lion symbol 50A to the mini-apple symbol 50K as well as the lion symbol 45A to the apple symbol 45K on the variable display portion 3B. That is, in the termination of the reel rotation control process (S14), there can be display symbols that are same in design but different in size on the variable display portion 3B. Then, a player feels that it is more difficult to grasp the game result due to the presence of the mini-symbol 50.

In this regard, the slot machine 1 according to the second embodiment handles the mini-symbols 50 (for example, the mini-gorilla symbols 50H) as the same kinds of symbols that are same in design but different in size (for example, the gorilla symbols 45H). And, the slot machine 1 according to the second embodiment executes the symbol layout change process (S16) on condition described above. That is, in the layout change screen, the main CPU 42 displays the fifteen symbols stopped along termination of the reel rotation control process (S14) changing layout of those symbols such that symbols of each identical kind (including the mini-symbol 50 same in design but different in size) are collected and re-indicated in order beginning from the largest number of symbols with a kind.

Accordingly, when looking at the variable display portion 3B, a player can easily find out the same kinds of the symbols. Thus, the player can easily count corresponding kinds of the symbols. In particular, even though the mini-symbols 50 are included, it is possible to easily find out the symbols that are handled as the same kinds of the symbols and to count the number of the symbols.

And, the slot machine 1 according to the second embodiment awards a prize according to the number of the symbols stopped on the variable display portion 3B and handled as the same kinds of the symbols to the player. Thus, even though the mini-symbols 50 are used, the slot machine 1 can reduce burden on a player that is required for grasping the game result.

Furthermore, the slot machine 1 according to the second embodiment can shorten a period that is required for a player to grasp the game result. In particular, when the mini-symbols 50 exist, the slot machine 1 according to the second embodiment can significantly shorten a period that is required for a player to grasp the game result. As a result, the slot machine 1 can shorten a period until a player begins to play a new game or a period until a player terminates a game. Therefore, the slot machine 1 can increase the turnover of a player.

In the symbol layout change process (S16), the main CPU 42 changes only the layout of the fifteen symbols stopped in the reel rotation control process (S14). That is, the main CPU 42 does not change the kinds and the number of the stopped fifteen symbols. In other words, the slot machine 1 can notify the game result of a player in an appropriate style without changing the game result determined in the symbol lottery process (S13).

The slot machine 1 identifies the kind of symbols which achieve the winning combination as the target symbol kind in the target symbol kind identification process (S21). In addition, in the layout change screen, the main CPU 42 additionally displays the target symbol kind emphasis images 90 on the symbol display areas on which the symbols corresponding to the target symbol kind are displayed (S24). As a result, even though the mini-symbols 50 are included, like the slot machine 1 according to the first embodiment, the slot machine 1 can further reduce burden on a player that is required for grasping the game result. Therefore, the slot machine 1 can further increase the turnover of a player.

Further, the slot machine 1 identifies the kind of symbols which achieve the winning combination as the target symbol kind in the target symbol kind identification process (S21). In the layout change screen (FIG. 20), the slot machine 1 additionally displays the target symbol number notification images 91 on the symbol display areas on which the symbols corresponding to the target symbol kind are displayed (S24). Accordingly, even though the mini-symbols 50 are included, a player can grasp the number of the displayed symbols corresponding to the target symbol kinds without counting the number of symbols by oneself. That is, the slot machine 1 directly notifies a player of the game result. Therefore, the slot machine 1 can reliably reduce burden on a player that is required for grasping the game result. This enables the slot machine 1 to increase the turnover of a player.

It is to be noted that the present invention is not limited to the above-mentioned embodiments, and various modifications and changes may be made thereto without departing from the scope and spirit of the invention.

For example, in the above-mentioned embodiments, the symbol layout change process (S16) is executed for only a base game of the main game process (S2). However, the symbol layout change process may also be executed for a free game of the bonus game process (S19).

Further, in the above-mentioned embodiments, the target symbol kind emphasis images 90 and the target symbol number notification images 91 are displayed on the kinds of the symbols that have achieved the winning combination. However, the target symbol kind emphasis images 90 and the target symbol number notification images 91 may be displayed on the kinds of the symbols that do not achieve the winning combination.

Furthermore, in the above-mentioned embodiments, if the winning combination is achieved (S15: YES), the symbol layout change process (S16) has been executed. However, the present invention is limited thereto. That is, even though the winning combination is not achieved (S15: NO), the symbol layout change process (S16) may be executed.

The target symbol kind emphasis images 90 and the target symbol number notification images 91 shown in FIG. 20 have been added to the target symbol kinds in the above-mentioned embodiments, but the present invention is not limited thereto. For example, it is possible to emphatically display the symbols that correspond to the target symbol kinds by changing the background color of the symbols for each target symbol kind, instead of by adding the target symbol kind emphasis images 90 so that the target symbol kinds can be distinguished.

Further, the target symbol number notification images 91 have been always displayed so as to overlap onto symbols, but the target symbol number notification images may be set so as to appear and disappear repeatedly at predetermined intervals. With this configuration, a player can look at the images of the symbols corresponding to the portions overlapping with the target symbol number notification images 91. Furthermore, the target symbol number notification images 91 may be displayed on separate locations except the symbol display areas.

In the above-mentioned embodiments, the display on the layout change screen has been terminated through the termination of a predetermined display period, but the present invention is not limited thereto. For example, the display on the layout change screen may be terminated based on the player's operation (the operation of the touch panel 4, the operation buttons 26, or the like). Accordingly, a player can terminate the display on the layout change screen at an arbitrary time. And, the player can play a new game at an arbitrary time. As a result, it is possible to increase the turnover of the slot machine 1.

In addition, in the above-mentioned embodiments, the process which uses the random number value in the symbol lottery processes (S13 and S31) has been executed using the random number value, the table associating the random number values and the code numbers (for example, refer to FIG. 15), and the table associating the symbols and the code numbers (refer to FIG. 14). However, the present invention is not limited thereto.

For example, the sampled random number values may be associated directly with the symbols. Further, the sampled random number values may be associated directly with the winning combination, and symbols to be stopped may be determined using the table associating the random numbers and the winning combination.

Furthermore, in the above-mentioned embodiments, the variable display portion 3B has been composed of a liquid crystal panel, but may be composed of a mechanical reel and a transparent liquid crystal display disposed on the front face of the mechanical reel. That is, the slot machine 1 may be composed not as a video slot machine but as a so-called hybrid slot machine. In this case, the design drawn on the mechanical reel is seen through the transparent liquid crystal display. In addition, it is preferable that a hybrid gaming machine be configured as follows: display windows of which the number is equal to the number of mechanical reels are provided to a transparent liquid crystal display, and design drawn on the mechanical reels can be seen through the display windows.

In this case, in the symbol layout change process (S16), symbols of which the layout has been changed are displayed on the transparent liquid crystal display. At this time, it is preferable that the symbols of which the layout has been changed be displayed at the display windows of the transparent liquid crystal display and the symbols of which the layout is not changed be hidden. With this configuration, it is possible to prevent a player from confounding the symbols of which the layout has been changed with the symbols of which the layout is not changed.

The present invention may also be embodied as a gaming method of executing the above-mentioned processes. Further, the present invention may also be embodied as a program for executing the game method with a computer, and a recording medium on which the program is recorded.

Although the subject. matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display that displays: a plurality of symbol display areas in each of which plural kinds of symbols are variably displayed and one symbol is stopped; and a symbol display portion constituted by arranging the plurality of symbol display areas in a matrix form;
and
a processor for executing:
(a) a process for receiving a bet of a game value, and beginning to variably display the symbols on the symbol display areas;
(b) a process for determining a symbol that is to be stopped on each of the symbol display areas, and stopping the determined. symbol on each of the symbol display areas disposed in the form of a matrix;
(c) a process for collecting by each identical kind in regard to the symbols that are stopped on the symbol display portion;
(d) a process for changing layout of the symbols into a layout such that the symbols disposed in order beginning from a largest number of stopped symbols with a kind;
(e) a process for displaying the symbols stopped on the symbol display portion again in accordance with the layout changed at (d); and
(f) a process for determining the contents of a prize according to the number of the same kinds of symbols stopped on the symbol display portion, and awarding the determined prize.

2. A gaming machine comprising:
a display that displays: a plurality of symbol display areas in each of which plural kinds of symbols are variably displayed and one symbol is stopped; and a symbol display portion constituted by arranging the plurality of symbol display areas in a matrix form;
and
a processor for executing:
(a) a process for receiving a bet of a game value, and beginning to variably display the symbols on the symbol display areas;
(b) a process for determining a symbol that is to be stopped on each of the symbol display areas, and stopping the determined symbol on each of the symbol display areas disposed in the form of a matrix;
(c) a process for collecting by each identical kind in regard to the symbols that are stopped on the symbol display portion;
(d) a process for changing layout of the symbols into a layout such that the symbols disposed in order beginning from a largest number of stopped symbols with a kind;
(e) a process for displaying the symbols stopped on the symbol display portion again in accordance with the layout changed at (d);
(f) a process for emphatically displaying a specific kind display area composed of symbol display areas that are collectively disposed in the symbol display portion and the same kinds of the symbols are stopped thereon; and
(g) a process for determining the contents of a prize according to the number of the same kinds of symbols stopped on the symbol display portion, and awarding the determined prize.

3. A gaming machine comprising:
a display that displays: a plurality of symbol display areas in each of which plural kinds of symbols are variably displayed and one symbol is stopped; and a symbol display portion constituted by arranging the plurality of symbol display areas in a matrix form;
and
a processor for executing:
(a) a process for receiving a bet of a game value, and beginning to variably display the symbols on the symbol display areas;
(b) a process for determining a symbol that is to be stopped on each of the symbol display areas, and stopping the determined symbol on each of the symbol display areas disposed in the form of a matrix;
(c) a process for collecting by each identical kind in regard to the symbols that are stopped on the symbol display portion;
(d) a process for changing layout of the symbols into a layout such that the symbols disposed in order beginning from a largest number of stopped symbols with a kind;
(e) a process for displaying the symbols stopped on the symbol display portion again in accordance with the layout changed at (d);
(f) a process for emphatically displaying a specific kind display area composed of the symbol display areas that are collectively disposed in the symbol display portion and the same kinds of the symbols are stopped thereon;
(g) a process for displaying the number of the kinds of the symbols, which are stopped on the symbol display areas of the specific kind display area, on the specific kind display area; and
(h) a process for determining the contents of a prize according to the number of the same kinds of symbols stopped on the symbol display portion, and awarding the determined prize.

4. A gaming machine comprising:
a display that displays: a plurality of symbol display areas in each of which plural kinds of symbols are variably displayed and one symbol is stopped; and a symbol display portion constituted by arranging the plurality of symbol display areas in a matrix form;
and
a processor for executing:
(a) a process for receiving a bet of a game value, and beginning to variably display the symbols on the symbol display areas;
(b) a process for determining a symbol that is to be stopped on each of the symbol display areas by lottery, and stopping the determined symbol on each of the symbol display areas disposed in the form of a matrix, thereby randomly disposing the plurality of symbols on the symbol display portion;
(c) a process for collecting by each identical kind in regard to the symbols that are stopped on the symbol display portion;
(d) a process for changing layout of the symbols into a layout such that the symbols disposed in order beginning from a largest number of stopped symbols with a kind;
(e) a process for displaying the symbols stopped on the symbol display portion again in accordance with the layout changed at (d); and
(f) a process for determining the contents of a prize according to the number of the same kinds of symbols stopped on the symbol display portion, and awarding the determined prize.

5. The gaming machine according to claim 4,
wherein the display displays each of the symbol display areas that variably displays a plurality of kinds of symbols, which include a first symbol and a second symbol that is same in design but different in size from the first symbol, and stops one symbol, and
the processor collects and disposes the first symbols and the second symbols stopped on the symbol display portion as the same kinds of symbols when the layout of the symbols stopped on the symbol display portion is changed, and
determines the contents of the prize on the basis of the sum of the numbers of the first symbols and the second symbols stopped on the symbol display portion when the prize based on the number of the same kinds of the symbols stopped on the symbol display portion is awarded.
